(19) United States
(12) Patent Application Publication
(10) Pub. No.: US 2025/0181035 A1
(43) Pub. Date: Jun. 5, 2025

(54) MECHANICAL TIMEPIECE

(71) Applicant: CITIZEN WATCH CO., LTD., Tokyo (JP)

(72) Inventors: Yu TAKYO, Nishitokyo-shi, Tokyo (JP); Yusaku NIIDA, Kawagoe-shi, Saitama (JP); Takuya SHIRAI, Inagi-shi, Tokyo (JP)

(21) Appl. No.: 18/846,031

(22) PCT Filed: Feb. 24, 2023
(86) PCT No.: PCT/JP2023/006827

§ 371 Date: Sep. 11, 2024

(30) Foreign Application Priority Data
Mar. 14, 2022 (JP) 2022-039230

(51) Int. Cl. G04C 3/06; G04C 5/00

(52) U.S. Cl. CPC G04C 3/064; G04C 5/005

(57) ABSTRACT

Provided is a mechanical timepiece in which rotation is maintained even when a torque caused by a spring force of a hairspring is decreased. The mechanical timepiece includes a power spring, a balance wheel, a hairspring, a permanent magnet, a coil, a soft magnetic core, and rate adjustment means. The permanent magnet is arranged so that, at a position of 0°, an S-pole portion is opposed to a first end portion with a first interval and an N-pole portion is opposed to a second end portion with a second interval, and, at a position of 180°, the S-pole portion is opposed to the second end portion with a third interval and the N-pole portion is opposed to the first end portion with a fourth interval.

### TECHNICAL FIELD

The present invention relates to a mechanical timepiece.

### BACKGROUND ART

In a related-art mechanical timepiece, one second is created based on a reciprocating motion of a balance including a balance wheel and a hairspring. When the number of reciprocating motions per second increases, an error per second, that is, an influence of a rate accuracy decreases. For example, in Patent Literature 1, there is disclosed a technology of improving the rate accuracy by reducing an inertia of an escapement to achieve high speed oscillation of the balance. Further, in Patent Literatures 2 and 3, there is disclosed a technology of adjusting a rate in a mechanical timepiece including a balance.

### CITATION LIST

### Patent Literature

[Patent Literature 1] JP2011-185932A
[Patent Literature 2] JP2019-113548A
[Patent Literature 3] JP2020-38206A

### SUMMARY OF INVENTION

### Technical Problem

In this case, when the frequency of the balance is increased by increasing the torque caused by a spring force of the hairspring, each mechanism for transmitting motive power is liable to be worn, and the durability is reduced. Meanwhile, when the frequency of the balance is decreased by reducing the torque caused by the spring force of the hairspring, the torque caused by the spring force of the hairspring cannot counteract against a frictional force caused between a pallet fork and an escape wheel and pinion, and there is a fear in that the rotation is stopped.

The present invention has been made in view of the above-mentioned problems, and has an object to provide a mechanical timepiece in which rotation is maintained even when a torque caused by a spring force of a hairspring is decreased.

### Solution to Problem

(1) A mechanical timepiece, including: a power source; a speed governing mechanism including: a balance wheel to be driven by motive power supplied from the power source; and a hairspring to be elastically deformed so as to cause the balance wheel to perform a forward/reverse rotational motion; a permanent magnet which includes a first polarity portion and a second polarity portion having a polarity different from a polarity of the first polarity portion, and is configured to perform a forward/reverse rotational motion along with the forward/reverse rotational motion of the balance wheel; a coil; a soft magnetic core including: a first end portion provided so as to cause a magnetic resistance with respect to the permanent magnet; and a second end portion provided on a side opposite to the first end portion through intermediation of the permanent magnet so as to cause a magnetic resistance with respect to the permanent magnet; and rate adjustment means for performing rate adjustment based on a detection voltage and a normal frequency of a reference signal source, the detection voltage being caused in the coil by a motion of the permanent magnet accompanying a forward direction motion and a reverse direction motion of the balance wheel, wherein the permanent magnet is arranged so that: at a first angle position under a state in which the hairspring is brought to a neutral position of elastic deformation thereof, the first polarity portion is opposed to the first end portion with a first interval, and the second polarity portion is opposed to the second end portion with a second interval; at a second angle position rotated by 180° from the first angle position, the first polarity portion is opposed to the second end portion with a third interval, and the second polarity portion is opposed to the first end portion with a fourth interval; and the second interval is smaller than the first interval, and a difference between the fourth interval and the third interval is smaller than a difference between the first interval and the second interval.

(2) The mechanical timepiece according to Item (1), wherein the permanent magnet has a circular planar shape, and wherein a center position of the permanent magnet is arranged at a position different from a rotation center of a balance staff which is a rotary shaft of the balance wheel.

(3) The mechanical timepiece according to Item (2), wherein, in the soft magnetic core, an inner peripheral surface of the first end portion and an inner peripheral surface of the second end portion form an opening having a circular planar shape, and wherein a center position of the opening of the soft magnetic core is arranged at a position different from the rotation center.

(4) The mechanical timepiece according to Item (3), wherein, under a state in which the permanent magnet is brought to the first angle position, the center position of the permanent magnet and the center position of the opening of the soft magnetic core are at positions symmetrical with each other with respect to the rotation center.

(5) The mechanical timepiece according to Item (4), wherein, under a state in which the permanent magnet is brought to the second angle position, the center position of the permanent magnet and the center position of the opening of the soft magnetic core match each other.

(6) The mechanical timepiece according to any one of Items (3) to (5), wherein, under a state in which the permanent magnet is brought to the first angle position, the center position of the permanent magnet, the rotation center of the rotary shaft, and the center position of the opening of the soft magnetic core are arranged side by side on a straight line orthogonal to a boundary line between the first polarity portion and the second polarity portion.

(7) The mechanical timepiece according to any one of Items (3) to (6), further including: a support member which is configured to support the soft magnetic core, and is fixed to a main plate; and a positioning frame which is mounted to the support member, and is configured to position the soft magnetic core, wherein the positioning frame is provided so that a center position thereof matches a rotation center of a balance staff which is a rotary shaft of the balance wheel, and includes a positioning projection which has an annular shape and is configured to be fitted to the opening of the soft magnetic core, and wherein a center position of the positioning projection is arranged at a position different from the center position of the positioning frame.

(8) The mechanical timepiece according to any one of Items (1) to (7), further including a holding member configured to hold the permanent magnet, wherein the holding member has formed therein an insertion hole through which a balance staff which is a rotary shaft of the balance wheel is to be inserted, and the holding member is to be rotated integrally with the balance staff under a state in which the balance staff is inserted through the insertion hole, and wherein a center position of the insertion hole is arranged at a position different from a center position of the holding member.

(9) The mechanical timepiece according to any one of Items (1) to (8), wherein, under a state in which the coil is brought to a de-energized state and the permanent magnet is brought between the first angle position and the second angle position, a magnetic attraction force acts between the permanent magnet and the soft magnetic core in a direction in which the permanent magnet is rotated toward the first angle position.

(10) The mechanical timepiece according to any one of Items (1) to (9), further including: a cap jewel configured to abut against one end of a balance staff which is a rotary shaft of the balance wheel to perform positioning of the balance staff in an axial direction; and a cap jewel holding member which is formed into an annular shape surrounding at least a part of an outer peripheral surface of the permanent magnet, and is configured to hold the cap jewel, wherein the cap jewel holding member is made of a magnetic material, and has a cutout formed in at least a part of a portion of the cap jewel holding member to be opposed to the outer peripheral surface of the permanent magnet.

(11) The mechanical timepiece according to any one of Items (1) to (10), wherein a forward/reverse rotational motion of a balance staff which is a rotary shaft of the balance wheel includes at least a period in which the balance staff idly rotates with respect to the hairspring and a period in which the balance staff transmits a rotational force to the hairspring and elastically deforms the hairspring.

(12) The mechanical timepiece according to Item (11), wherein the hairspring is unfixed to the balance staff.

(13) The mechanical timepiece according to Item (11) or (12), further including a contact portion configured to repeat contact and non-contact with respect to the hairspring along with the forward/reverse rotational motion of the balance staff.

(14) The mechanical timepiece according to Item (13), wherein the hairspring includes: a spring portion which is elastically deformable and has a spiral shape; an inner end portion through which the balance staff is to be inserted; and a connection portion which connects the spring portion and the inner end portion to each other and forms a gap that allows the contact portion to move between the spring portion and the inner end portion.

(15) The mechanical timepiece according to Item (14), wherein a period in which a rotation angle of the balance staff is at least 0° or more and less than 180° includes a period in which the contact portion is not in contact with respect to the connection portion.

(16) The mechanical timepiece according to Item (14) or (15), further including a holding member which is configured to hold the permanent magnet, and is to be rotated integrally with the balance staff, wherein the contact portion is provided in the holding member.

(17) The mechanical timepiece according to Item (14) or (15), further including a holding member which is configured to hold the permanent magnet, and is to be rotated integrally with the balance staff, wherein the contact portion is provided in a member separate from the holding member, the member being configured to be rotated integrally with the balance staff.

(18) The mechanical timepiece according to any one of Items (14) to (17), wherein a planar shape of the connection portion is a shape including a part expanding toward a radially outer side, and wherein a period in which the balance staff idly rotates with respect to the hairspring is defined depending on an expansion degree of the part expanding toward the radially outer side.

(19) The mechanical timepiece according to any one of Items (14) to (18), wherein a planar shape of the connection portion is a shape including a part in which a distance from a rotation center of the hairspring is shorter than a radius of a rotation locus of an outermost portion of the connection portion.

(20) The mechanical timepiece according to any one of Items (8), (16), or (17), wherein the holding member includes a center-of-gravity adjusting portion configured to adjust a center of gravity of a rotary member formed of the permanent magnet and the holding member.

### Advantageous Effects of Invention

According to the aspects of Items (1) to (20) of the present invention as described above, the mechanical timepiece in which rotation is maintained even when a torque caused by a spring force of the hairspring is decreased can be provided.

### BRIEF DESCRIPTION OF DRAWINGS

FIG. 1 is a perspective view for illustrating a main plate and each member to be incorporated thereto in a first embodiment of the present invention.

FIG. 2 is a perspective view for illustrating a mechanism for transmitting motive power and its surroundings in the first embodiment.

FIG. 3 is a plan view for illustrating a pallet fork, an escape wheel and pinion, and their surrounding members in the first embodiment.

FIG. 4 is an explanatory graph for showing a rotation range and a rotation direction of a balance wheel in the first embodiment.

FIG. 5 is a block diagram for illustrating an overall configuration of a mechanical timepiece according to the first embodiment.

FIG. 6 shows explanatory graphs of a relationship between an operation of the balance wheel and a counter-electromotive voltage to be caused in a coil in the first embodiment.

FIG. 7A is a plan view for illustrating an arrangement of a permanent magnet, a soft magnetic core, and a balance staff in the first embodiment.

FIG. 7B is a plan view for illustrating the arrangement of the permanent magnet, the soft magnetic core, and the balance staff in the first embodiment.

FIG. 8 is an explanatory graph for showing each torque acting on the permanent magnet in the first embodiment.

FIG. 9 is a plan view for illustrating an arrangement of a permanent magnet, a soft magnetic core, and a balance staff in a comparative example.

FIG. 10 is an explanatory graph for showing each torque acting on the permanent magnet in the comparative example.

FIG. 11 is a perspective view for illustrating members rotating together with the balance staff in the first embodiment.

FIG. 12 is an exploded perspective view for illustrating the members illustrated in FIG. 11 in a disassembled manner.

FIG. 13 is a perspective view for illustrating a bottom portion of a holding member in the first embodiment.

FIG. 14A is a perspective view for illustrating the holding member in the first embodiment.

FIG. 14B is a plan view for illustrating the holding member in the first embodiment.

FIG. 15 is an exploded perspective view for illustrating the balance staff and a roller table in a disassembled manner.

FIG. 16 is a perspective view for illustrating the soft magnetic core and its surrounding members in the first embodiment.

FIG. 17 is an exploded perspective view for illustrating the soft magnetic core illustrated in FIG. 16 which is disassembled from a support member.

FIG. 18A is a perspective view for illustrating a positioning frame in the first embodiment.

FIG. 18B is a plan view for illustrating the positioning frame in the first embodiment.

FIG. 18C is a perspective view for illustrating the positioning frame in the first embodiment.

FIG. 19 is a perspective view for illustrating a bearing structure and its surrounding members in the first embodiment.

FIG. 20 is a perspective view for illustrating a cap jewel holding member in the first embodiment.

FIG. 21 is a plan view for illustrating the cap jewel holding member and its surrounding members in the first embodiment.

FIG. 22 is a plan view for illustrating the arrangement of the permanent magnet, the soft magnetic core, and the balance staff in a first modification example of the first embodiment.

FIG. 23 is a plan view for illustrating the arrangement of the permanent magnet, the soft magnetic core, and the balance staff in a second modification example of the first embodiment.

FIG. 24 is a plan view for illustrating the arrangement of the permanent magnet, the soft magnetic core, and the balance staff in a third modification example of the first embodiment.

FIG. 25 is an explanatory graph for showing each torque acting on a permanent magnet in a second embodiment of the present invention.

FIG. 26 is an exploded perspective view for illustrating a balance wheel, a balance staff, a permanent magnet, a hairspring, and their surrounding members in the second embodiment in a disassembled manner.

FIG. 27 is a perspective view for illustrating a holding member in the second embodiment.

FIG. 28 is a cross-sectional view for illustrating the balance wheel, the balance staff, the permanent magnet, the hairspring, and the holding member in the second embodiment.

FIG. 29A shows a state in which a rotation angle of the balance wheel is 0°.

FIG. 29B shows a state in which the rotation angle of the balance wheel is 135°.

FIG. 29C shows a state in which the rotation angle of the balance wheel is 315°.

FIG. 29D shows a state in which the rotation angle of the balance wheel is −135°.

FIG. 29E shows a state in which the rotation angle of the balance wheel is −315°.

FIG. 30A is a perspective view for illustrating a projecting portion in a modification example of the second embodiment.

FIG. 30B is a cross-sectional view in a case of using the projecting portion in the modification example of the second embodiment.

FIG. 31 is a perspective view for illustrating a modification example of the holding member.

FIG. 32 is a perspective view for illustrating a modification example of the permanent magnet.

FIG. 33 is an explanatory view for illustrating a modification example regarding arrangement angles of the permanent magnet and the soft magnetic core.

FIG. 34 is a plan view for illustrating a modification example of the hairspring.

### DESCRIPTION OF EMBODIMENTS

Description is made below in detail of each of embodiments of the present invention based on the drawings.

[Outline of Overall Configuration]

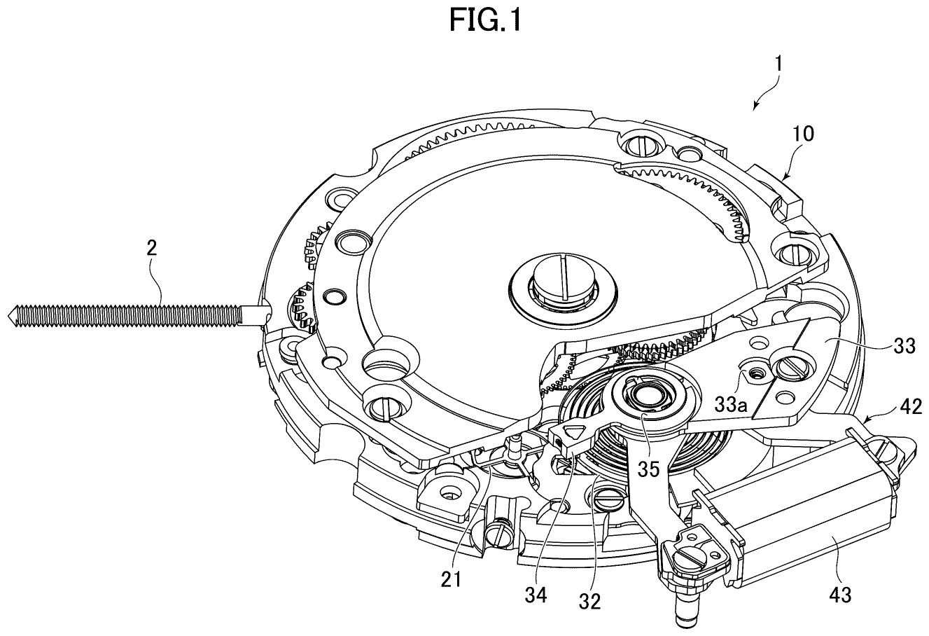

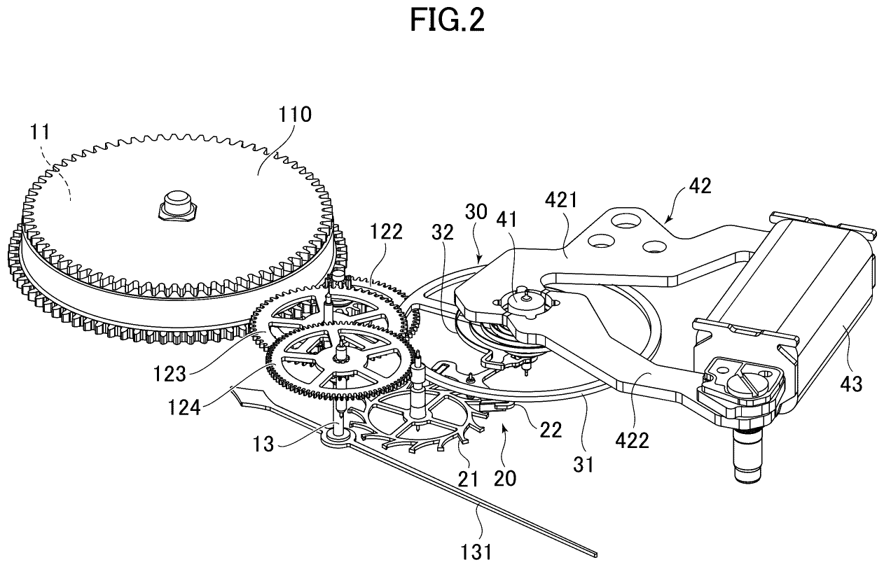

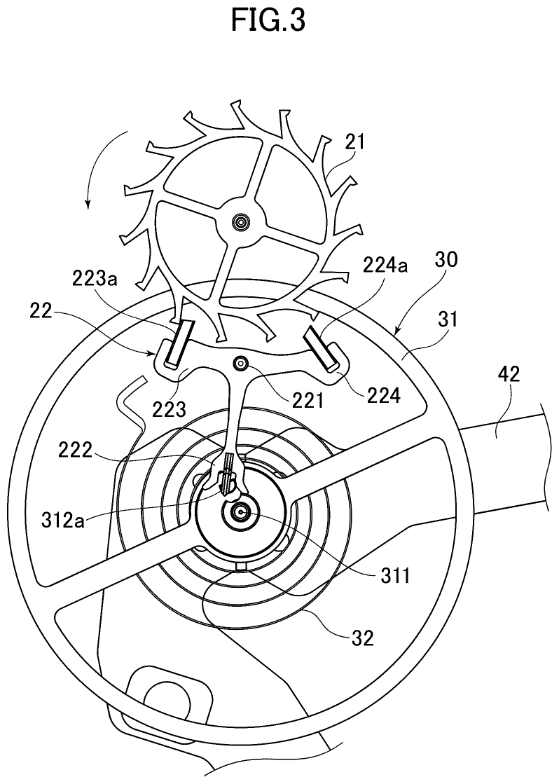

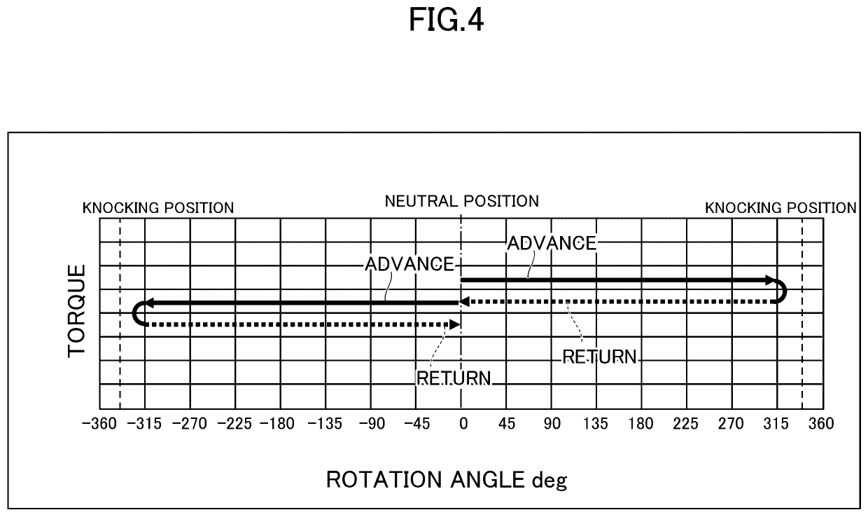

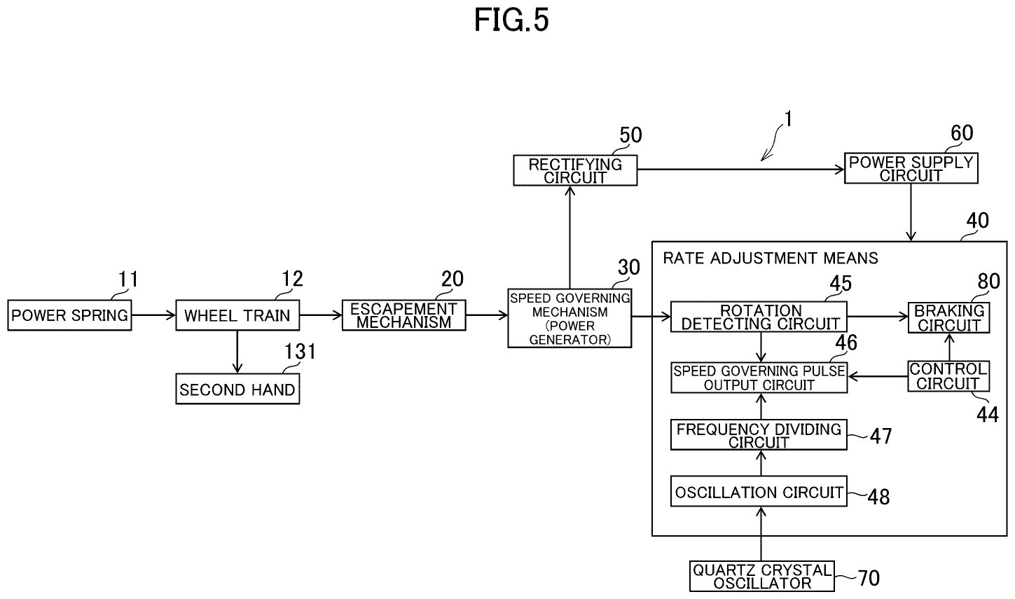

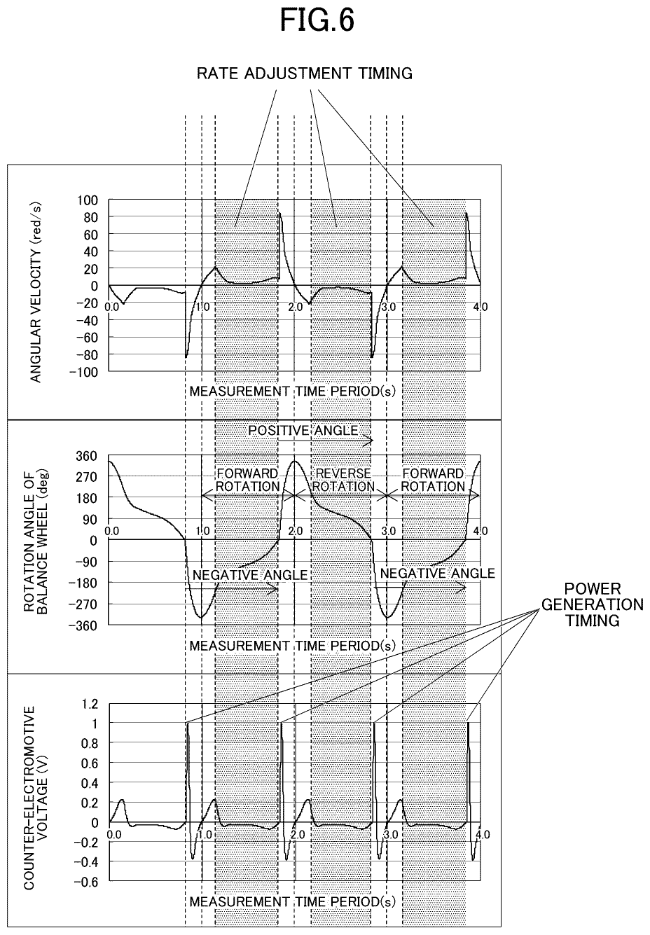

First, with reference to FIG. 1 to FIG. 6, an outline of an overall configuration of a mechanical timepiece 1 according to a first embodiment is described. FIG. 1 is a perspective view for illustrating a main plate and each member to be incorporated thereto in the first embodiment. FIG. 2 is a perspective view for illustrating a mechanism for transmitting motive power and its surroundings in the first embodiment. FIG. 3 is a plan view for illustrating a pallet fork, an escape wheel and pinion, and their surrounding members in the first embodiment. FIG. 4 is an explanatory graph for showing a rotation range and a rotation direction of a balance wheel in the first embodiment. FIG. 5 is a block diagram for illustrating an overall configuration of the mechanical timepiece according to the first embodiment. FIG. 6 is an explanatory graph for showing a relationship between an operation of the balance wheel and a counter-electromotive voltage to be caused in a coil in the first embodiment. FIG. 1 and FIG. 2 show a state in which the mechanical timepiece 1 is viewed from its back side, and FIG. 3 shows a state in which the mechanical timepiece 1 is viewed from its front side. The back side refers to a side on which a back cover of an exterior case is arranged in a thickness direction of the mechanical timepiece 1, and the front side refers to a side on which a dial is arranged in the thickness direction of the mechanical timepiece 1.

The mechanical timepiece 1 is a timepiece which uses a power spring 11 as a power source, and uses an escapement mechanism 20 and a speed governing mechanism 30 to control a motion of the power spring 11 and also drive hands. The mechanical timepiece 1 is formed by accommodating, into an exterior case, a main plate 10 to which each mechanism for driving the hands is incorporated. In the first embodiment, illustration of the exterior case is omitted. Further, illustration of a crown to be arranged on a side surface of the exterior case is also omitted. The crown is mounted to an end portion of a winding stem 2 illustrated in FIG. 1.

### [Outline of Overall Configuration: Configuration of Drive Mechanism]

An outline of a drive mechanism included in the mechanical timepiece 1 is described. In the first embodiment, a mechanism including the power spring 11 serving as the power source, a wheel train, and a hand shaft 13 is referred to as “drive mechanism.” In FIG. 2, only a second hand 131 among the hands is illustrated. The drive mechanism illustrated in FIG. 2 is merely an example, and the present invention is not limited thereto. The drive mechanism may include gears or the like other than the illustrated gears.

The power spring 11 is formed of a band-like member made of a metal, and is accommodated into a barrel 110 having a plurality of teeth formed on an outer periphery thereof. The barrel 110 has a disc shape, and has a cavity formed therein for accommodating the power spring 11. The power spring 11 has its inner end fixed to a barrel arbor (not shown) serving as a rotary shaft provided at the center of the barrel 110, and has its outer end fixed to an inner side surface of the barrel 110. When the crown is rotated through the operation of the user, the winding stem 2 is rotated. Along with the rotation of the winding stem 2, the power spring 11 is wound up. The wound power spring 11 is unwound due to its elastic force. The barrel 110 is rotated along with the operation of the power spring 11 at this time.

The wheel train at least includes a center wheel and pinion 122, a third wheel and pinion 123, and a fourth wheel and pinion 124. The center wheel and pinion 122 includes a pinion for meshing with the plurality of teeth formed on the barrel 110 functioning as a mainwheel, a rotary shaft, and a plurality of teeth. The center wheel and pinion 122 transmits the rotation of the barrel 110 to the third wheel and pinion 123. The rotary shaft of the center wheel and pinion 122 is a hand shaft of a minute hand (not shown). The third wheel and pinion 123 includes a pinion for meshing with the plurality of teeth of the center wheel and pinion 122, a rotary shaft, and a plurality of teeth. The third wheel and pinion 123 transmits the rotation of the center wheel and pinion 122 to the fourth wheel and pinion 124. The fourth wheel and pinion 124 includes a pinion meshing with the plurality of teeth of the third wheel and pinion 123, a rotary shaft, and a plurality of teeth. The fourth wheel and pinion 124 transmits the rotation of the third wheel and pinion 123 to the escapement mechanism 20. As illustrated in FIG. 2, the rotary shaft of the fourth wheel and pinion 124 is the hand shaft 13 of the second hand 131.

### [Outline of Overall Configuration: Outline of Configurations of Escapement Mechanism 20 and Speed Governing Mechanism 30, and Operations Thereof]

Next, the escapement mechanism 20 and the speed governing mechanism 30 are described. The motive power from the power spring 11 is transmitted via the wheel train to the escapement mechanism 20 and the speed governing mechanism 30. The escapement mechanism 20 includes an escape wheel and pinion 21 and a pallet fork 22. The speed governing mechanism 30 includes a balance wheel 31 and a hairspring 32. The speed governing mechanism 30 is sometimes referred to as “balance with hairspring.”

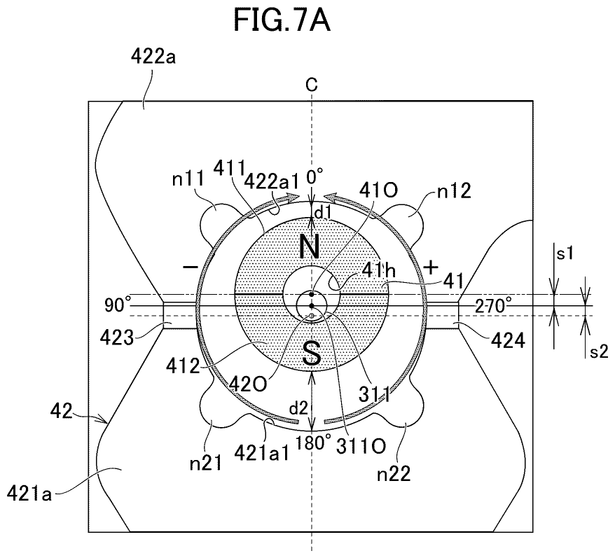

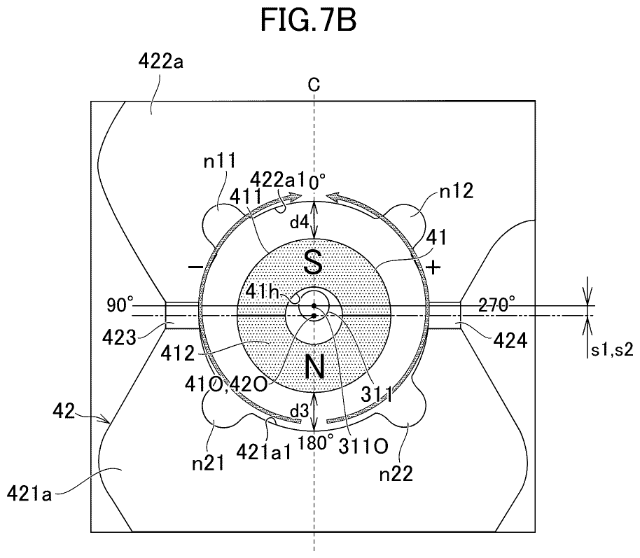

The balance wheel 31 performs a forward/reverse rotational motion about the balance staff 311 being a rotation center of the balance wheel 31, through use of the motive power transmitted by the wheel train. In the following description, in the forward/reverse rotational motion, a forward direction motion is referred to as “rotation in the forward direction,” and a reverse direction motion is referred to as “rotation in the reverse direction.” In the first embodiment, description is given assuming that, in the figures including FIG. 7A and the like, a counterclockwise direction is the rotation in the forward direction and a clockwise direction is the rotation in the reverse direction.

As illustrated in FIG. 3, it is preferred that the balance wheel 31 have a circular outer shape. However, the shape of the balance wheel 31 illustrated in FIG. 3 is merely an example, and the shape of the balance wheel 31 may be freely selected.

The hairspring 32 performs an expansion/contraction motion (elastic deformation) so as to cause the balance wheel 31 to perform the forward/reverse rotational motion. The hairspring 32 has a spiral shape, and has an inner end fixed with respect to the balance staff 311 and an outer end fixed with respect to a stud support 34. The stud support 34 is fixed with respect to the main plate 10 together with the support member 33.

The escape wheel and pinion 21 is a component for meshing with the pallet fork 22 so as to receive, from the pallet fork 22, rhythm kept by the speed governing mechanism 30, thereby converting the rhythm into a regular rotational motion. The escape wheel and pinion 21 includes a pinion for meshing with the plurality of teeth of the fourth wheel and pinion 124, a rotary shaft, and a plurality of teeth. As illustrated in FIG. 2, the plurality of teeth of the escape wheel and pinion 21 are formed at intervals wider in a circumferential direction than intervals of the teeth of each gear of the wheel train.

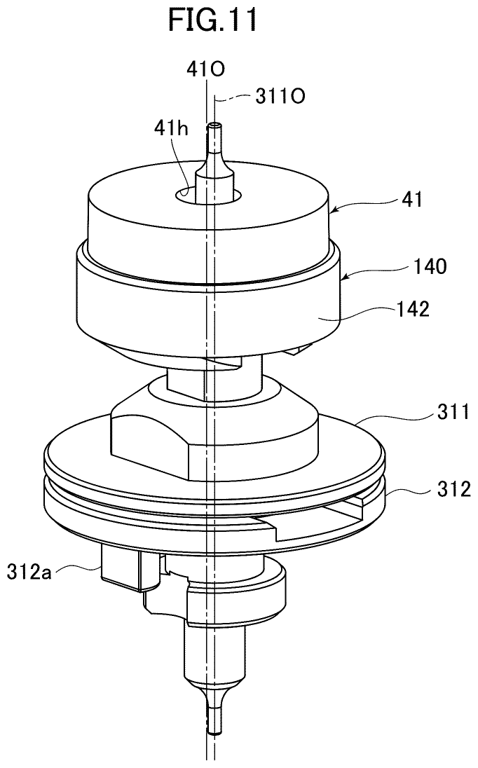

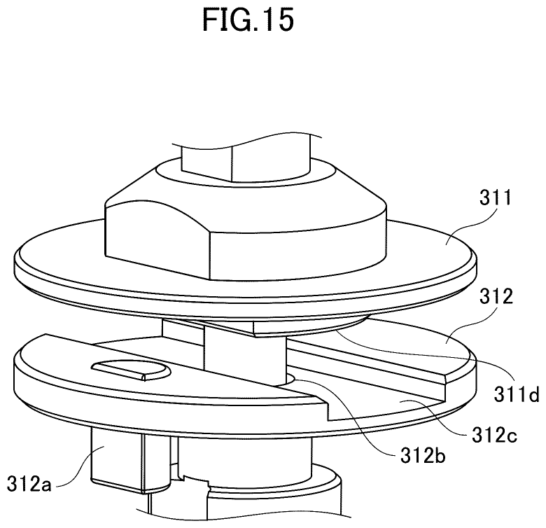

The pallet fork 22 uses a pallet fork staff 221 illustrated in FIG. 3 as a rotary shaft so as to perform a forward/reverse rotational motion. The pallet fork 22 includes a lever portion 222. The lever portion 222 extends from the pallet fork staff 221 toward a center of the balance wheel 31 (balance staff 311), and collides with an impulse jewel 312a which rotates together with the balance staff 311. A distal end of the lever portion 222 is formed into a U-shape, and is sometimes called a pallet receptacle. The impulse jewel 312a is fixed to a roller table 312 (see FIG. 11, FIG. 15, and the like) rotating together with the balance staff 311.

The pallet fork 22 includes a first arm portion 223, and a second arm portion 224 extending in a direction opposite to the first arm portion 223. An entry pallet 223a for colliding with the plurality of teeth of the escape wheel and pinion 21 is mounted to the first arm portion 223, and an exit pallet 224a for colliding with the plurality of teeth of the escape wheel and pinion 21 is mounted to the second arm portion 224. It is preferred that each of the entry pallet 223a and the exit pallet 224a be, for example, a stone such as a sapphire.

An operation of the speed governing mechanism 30 is described with reference to FIG. 3. A torque for rotation in the arrow direction indicated in FIG. 3 is always applied to the escape wheel and pinion 21 along with the rotation of the fourth wheel and pinion 124, and the escape wheel and pinion 21 is stopped when the tooth of the escape wheel and pinion 21 collides with the entry pallet 223a of the pallet fork 22. When the balance wheel 31 is rotated, the impulse jewel 312a pushes the pallet receptacle to rotate the pallet fork 22, and thus the stopping between the pallet fork 22 and the escape wheel and pinion 21 is canceled. After the stopping cancelation is ended, the tooth of the escape wheel and pinion 21 pushes the entry pallet 223a upward to rotate the pallet fork 22. The impulse jewel 312a has pushed the pallet receptacle so far, but conversely, the pallet receptacle pushes the impulse jewel 312a so that the rotational energy is transmitted to the balance wheel 31. When the tooth of the escape wheel and pinion 21 is separated away from the entry pallet 223a, the escape wheel and pinion 21 idly rotates, and next the escape wheel and pinion 21 stops again at a position at which the tooth of the escape wheel and pinion 21 hits the exit pallet 224a. After the balance wheel 31 which has received the rotational energy is rotated, the balance wheel 31 is rotated in the reverse direction by the spring toque of the hairspring 32, and an operation similar to that described above is also performed on the exit pallet 224a side. In this manner, regular and intermittent rotation of the escape wheel and pinion 21 and the wheel train is achieved. As described later, the balance wheel 31 is designed to perform one back-and-forth operation in two seconds, and thus the escape wheel and pinion 21 performs one-step operation in one second.

In the first embodiment, a resin material having a low Young's modulus is adopted as the material of the hairspring 32. In this manner, as compared to a case in which the hairspring 32 is made of a metal material, low speed oscillation of the balance wheel 31 can be achieved. When the low speed oscillation is to be achieved by a metal hairspring, it is required to reduce the cross-sectional area of the hairspring 32 to a level that is difficult to process, or to increase the hairspring length to a level that is difficult to handle.

In the first embodiment, as the material of the hairspring 32, a resin having the Young's modulus of about 5 [GPa] is used. Specifically, as the material of the hairspring 32, polyester is used. It is preferred that the hairspring 32 made of a resin material be manufactured by, for example, laser processing. A general hairspring made of a metal has a Young's modulus of about 200 [GPa]. The Young's modulus given here is merely an example, and it is preferred that the Young's modulus of the hairspring 32 be 20 [GPa] or less. That is, it is preferred that the Young's modulus of the hairspring 32 be 1/10 or less of the Young's modulus of the hairspring made of a metal. It is more preferred that the Young's modulus of the hairspring 32 be 10 [GPa] or less. That is, it is preferred that the Young's modulus of the hairspring 32 be 1/20 or less of the Young's modulus of the hairspring made of a metal. Further, the Young's modulus is only required to be 20 [GPa] or less, and thus the hairspring 32 may be made of a material such as paper or wood.

Further, in the first embodiment, the rotation angle [deg] of each of the balance wheel 31 and the permanent magnet 41 under a state in which the hairspring 32 is brought to a neutral position of elastic deformation is defined as 0°. The neutral position of elastic deformation of the hairspring 32 refers to, in other words, a position at which the hairspring 32 has an equilibrium length. It is assumed that the balance wheel 31 in a state in which the hairspring 32 is brought around the neutral position of elastic deformation is supplied with the motive power from the power spring 11. Further, as described later, in the first embodiment, the permanent magnet 41 is brought to a magnetically balanced position at the position of the rotation angle of 0°

Further, in the first embodiment, as shown in FIG. 4, the balance wheel 31 is designed to be driven in a range of from a rotation angle of 340° to a rotation angle of −340°, which is a range in which the balance wheel 31 does not reach a knocking position. The knocking position refers to a position at which the impulse jewel 312a excessively rotates to collide with the lever portion 222 of the pallet fork 22. The balance wheel 31 performs the forward/reverse rotational motion in a range not exceeding the knocking position, and hence the permanent magnet 41 is also driven in the range of from the rotation angle of 340° to the rotation angle of −340°.

The solid line of FIG. 4 indicates a range in which the balance wheel 31 advances from the position of 0° by the motive power of the power spring 11, and the dotted line of FIG. 4 indicates a range in which the balance wheel 31 returns from the positions of ±340° by an elastic force of the hairspring 32.

This range is merely an example, and it is preferred that the moving range of the balance wheel 31 be equal to or larger than the range of from a rotation angle of 270° to a rotation angle of −270°. When the moving range of the balance wheel 31 is increased to some extent as described above, the low speed oscillation of the balance wheel 31 can be achieved.

As described above, the speed governing mechanism 30 causes the balance wheel 31 to repeatedly perform the forward/reverse rotational motion (reciprocating motion) in a certain cycle, through use of the expansion/contraction motion of the hairspring 32. The escapement mechanism 20 continuously applies, to the balance wheel 31, a force for performing the reciprocating motion, and each gear in the wheel train is rotated at a constant speed by the regular oscillation from the balance wheel 31.

### [Outline of Overall Configuration: Configuration of Rate Adjustment Means 40]

Next, a configuration of rate adjustment means 40 is described. The mechanical timepiece 1 according to the first embodiment includes the rate adjustment means 40 in addition to the drive mechanism, the escapement mechanism 20, and the speed governing mechanism 30.

The rate adjustment means 40 includes a permanent magnet 41, a soft magnetic core 42 (sometimes referred to as “stator”), a coil 43, and various circuits (see FIG. 5). The rate adjustment means 40 performs rate adjustment based on a detection signal to be detected based on the forward/reverse rotational motion of the permanent magnet 41, and on a normal frequency of a quartz crystal oscillator 70 serving as a reference signal source. In the first embodiment, the quartz crystal oscillator 70 is used as a reference signal source for achieving a high frequency accuracy, but the present invention is not limited thereto. For example, a CR oscillator formed of a capacitor and a resistor may be used.

Although not shown, it is preferred that the coil 43 be arranged so as to overlap, in plan view, a casing frame provided on the inner side of the exterior case. As another example, it is preferred that a cutout be formed in a part of the casing frame in the circumferential direction, and the coil 43 be arranged inside of this cutout.

The permanent magnet 41 is a disc-shaped rotary member magnetized into two poles, and is magnetized into an N pole and an S pole in the radial direction. That is, the permanent magnet 41 is a magnet including an N-pole portion 411 which is a second polarity portion, and an S-pole portion 412 which is a first polarity portion having a polarity different from that of the second polarity portion. Further, an insertion hole 41h through which the balance staff 311 is to be inserted is formed at a center portion of the permanent magnet 41. It is preferred that a diameter of the insertion hole 41h of the permanent magnet 41 be sufficiently larger than a diameter of a part of the balance staff 311 to be inserted through the insertion hole 41h of the permanent magnet 41.

The permanent magnet 41 is provided so as to perform a forward/reverse rotational motion along with the forward/reverse rotational motion of the balance wheel 31 (balance staff 311). That is, the permanent magnet 41 performs the forward/reverse rotational motion together with the balance wheel 31 so that its rotation angle becomes the same as the rotation angle of the balance wheel 31.

It is preferred that the permanent magnet 41 be an isotropic magnet having an axis of easy magnetization directed in a random direction. It is preferred that the permanent magnet 41 be magnetized by being applied with a magnetic field by a Helmholtz coil or the like under a state in which the permanent magnet 41 is held by a holding member 140 to be described later, which has been mounted to the balance staff 311. When such a magnetization method is adopted, a direction of magnetization of the permanent magnet 41 can be accurately adjusted.

The soft magnetic core 42 is made of a soft magnetic material, and includes a first magnetic portion 421 and a second magnetic portion 422. The soft magnetic core 42 forms a magnetic circuit together with the coil 43. The first magnetic portion 421 includes a first end portion 421a to be provided so as to be opposed to an outer peripheral surface of the permanent magnet 41, and the second magnetic portion 422 includes a second end portion 422a to be provided so as to be opposed to the outer peripheral surface of the permanent magnet 41. The first end portion 421a is a part of the t magnetic portion 421 including an inner peripheral surface 421al having a curved-surface shape along the outer peripheral surface of the permanent magnet 41. The second end portion 422a is a part of the second magnetic portion 422 including an inner peripheral surface 422a1 having a curved-surface shape along the outer peripheral surface of the permanent magnet 41.

The second end portion 422a is provided on a side opposite to the first end portion 421a through intermediation of the permanent magnet 41. The first end portion 421a and the second end portion 422a are arranged to surround the outer peripheral surface of the permanent magnet 41 so as to cause a magnetic resistance between the permanent magnet 41 and each of the first end portion 421a and the second end portion 422a.

Now, with reference mainly to FIG. 7A, details of the configuration of the soft magnetic core 42 are described. The soft magnetic core 42 includes a first welding portion 423 and a second welding portion 424. The first welding portion 423 is for separating the magnetic coupling between the first end portion 421a and the second end portion 422a. The second welding portion 424 is for separating the magnetic coupling between the first end portion 421a and the second end portion 422a. The second separating portion is arranged so as to be opposed to the first welding portion 423 through intermediation of the permanent magnet 41. It is preferred that the first welding portion 423 and the second welding portion 424 be formed inside a gap for physically separating the first end portion 421a and the second end portion 422a from each other.

The permanent magnet 41 is brought to a magnetically balanced position when the permanent magnet 41 is brought into a state of being positioned so that the direction of magnetization is orthogonal to an opposing direction of the first welding portion 423 and the second welding portion 424. In the first embodiment, the magnetically balanced position of the permanent magnet 41 is defined as a rotation angle of 0°.

Further, in the first embodiment, notches are formed in the inner peripheral surface 421al of the first end portion 421a and the inner peripheral surface 422al of the second end portion 422a of the soft magnetic core 42. Specifically, a notch n11 and a notch n12 are formed in the inner peripheral surface 422a1 of the second end portion 422a. Further, in the inner peripheral surface 421a1 of the first end portion 421a, a notch n22 is formed so as to be opposed to the notch n11 through intermediation of the permanent magnet 41, and a notch n21 is formed so as to be opposed to the notch n12 through intermediation of the permanent magnet 41. When the notches are formed as described above, the flow of the magnetic fluxes around the permanent magnet 41 is changed so that the magnetic influence to be received by the permanent magnet 41 from the soft magnetic core 42 is reduced. The number of notches, the interval between the notches, and the shape of each notch are not limited to those illustrated in FIG. 7A.

In the first embodiment, there is shown an example in which the first end portion 421a and the second end portion 422a of the soft magnetic core 42 are integrated with each other through intermediation of the first welding portion 423 and the second welding portion 424, but the present invention is not limited thereto. For example, the soft magnetic core 42 may not include the first welding portion 423 and the second welding portion 424, and the magnetic coupling between the first end portion 421a and the second end portion 422a may be separated via a gap. Further, the present invention is not limited to a case of completely separating the magnetic coupling. For example, the first end portion 421a and the second end portion 422a may be physically connected to each other through intermediation of a narrowing portion.

Further, as illustrated in FIG. 5, the rate adjustment means 40 includes a control circuit 44, a rotation detecting circuit 45, a speed governing pulse output circuit 46, a frequency dividing circuit 47, an oscillation circuit 48, and a braking circuit 80. In FIG. 5, illustration of the above-mentioned permanent magnet 41, soft magnetic core 42, and coil 43 is omitted. The configuration of the rate adjustment means 40 illustrated in FIG. 5 is merely an example. The rate adjustment means 40 is not required to independently include the circuits illustrated in FIG. 5, and the rate adjustment means 40 is only required to be capable of implementing the functions described below.

The control circuit 44 is a circuit for controlling operations of the respective circuits included in the rate adjustment means 40.

It is preferred that the control circuit 44 perform braking control of controlling a braking force for braking the permanent magnet 41 by controlling the braking circuit 80. It is preferred that the braking force act on the permanent magnet 41 based on, for example, an electromagnetic brake. The electromagnetic brake refers to a braking force obtained by such an induced electromotive force that causes a magnetic field in a direction that hinders the change in the magnetic flux caused in the coil 43 along with the rotation of the permanent magnet 41 when the first terminal and the second terminal of the coil 43 are short-circuited to achieve a closed loop state. It is preferred that the braking force act on the permanent magnet 41 at a timing other than the timing at which power generation is performed. Specifically, it is preferred that the electromagnetic brake act in a period other than a period indicated by band-shaped broken lines of FIG. 6 in which power generation is performed.

The oscillation circuit 48 outputs a predetermined oscillation signal based on the frequency of the quartz crystal oscillator 70. The frequency of the quartz crystal oscillator 70 is 32,768 [Hz]. The frequency dividing circuit 47 divides the frequency of the oscillation signal output from the oscillation circuit 48. The frequency dividing circuit 47 divides the frequency of the oscillation signal which is based on the quartz crystal oscillator 70 so as to generate a reference signal OS output roughly at every 1,000 [ms]. However, the present invention is not limited thereto, and the reference signal OS may be output at every 2,000 [ms] or every 3,000 [ms]. That is, the reference signal OS is only required to be output at every right seconds. Moreover, the present invention is not limited thereto, and the reference signal OS is only required to correspond to the cycle of the speed governing mechanism 30.

The rotation detecting circuit 45 detects a detection signal based on a voltage waveform caused in the coil 43 due to the motion of the permanent magnet 41. In the first embodiment, a signal to be detected by the rotation detecting circuit 45 when a counter-electromotive voltage having a predetermined threshold value or more is generated is defined as a detection signal.

The speed governing pulse output circuit 46 outputs a speed governing pulse based on the reference signal generated by the frequency dividing circuit 47 and on the detection signal detected by the rotation detecting circuit 45. Specifically, a detection timing of the detection signal detected by the rotation detecting circuit 45 and an output timing of the reference signal of about 1,000 [Hz] are compared with each other, and when there is a time lag between those timings, the speed governing pulse output circuit 46 outputs the speed governing pulse so that the cycle in which the detection signal is detected comes close to 1,000 [ms] (=one second).

The output of the speed governing pulse is performed through energization of the coil 43. Accordingly, it is preferred that, when the cycle in which the detection signal is detected is faster than the reference signal, the speed governing pulse output circuit 46 energize the coil 43 so that a torque acts in a direction of slowing down the movement of the permanent magnet 41, and, when the cycle in which the detection signal is detected is slower than the reference signal, the speed governing pulse output circuit 46 energize the coil 43 so that a torque acts in a direction of accelerating the movement of the permanent magnet 41.

### [Outline of Overall Configuration: Speed Governing Mechanism 30 Serving as Power Generator]

With reference to FIG. 6, the speed governing mechanism 30 serving as a power generator in the first embodiment is described.

FIG. 6 shows explanatory graphs of a relationship between the operation of the balance wheel and a counter-electromotive voltage to be caused in the coil in the first embodiment. In the graph at the upper stage of FIG. 6, the vertical axis represents an angular velocity [rad/s] of the balance wheel 31, and the horizontal axis represents a measurement time period [s]. In the graph at the middle stage of FIG. 6, the vertical axis represents a rotation angle [deg] of the balance wheel 31, and the horizontal axis represents the measurement time period [s]. In the graph at the lower stage of FIG. 6, the vertical axis represents a counter-electromotive voltage [V] to be caused in the coil 43, and the horizontal axis represents the measurement time period [s]. Further, the graphs of FIG. 6 show an example in which the movement of the balance wheel 31 (permanent magnet 41) is measured for four seconds.

The mechanical timepiece 1 has a power generating function using a principle of electromagnetic induction. In the first embodiment, the speed governing mechanism 30 functions as a part of the power generator. Specifically, the permanent magnet 41 performs the forward/reverse rotational motion along with the forward/reverse rotational motion of the balance wheel 31, and electric power is generated by a current caused in the coil 43 based on a change in a magnetic field caused by the motion of the permanent magnet 41. The power supply circuit 60 is activated through use of the electric power extracted by such an operating principle. When the power supply circuit 60 is activated, the control circuit 44 can be driven. Because such a configuration is adopted, in the first embodiment, the control circuit 44 can be driven without separately providing a power supply such as a battery.

A rectifying circuit 50 rectifies the current caused in the coil 43 due to the motion of the permanent magnet 41 accompanying the forward direction motion and the reverse direction motion in the forward/reverse rotational motion of the balance wheel of the speed governing mechanism 30. The power supply circuit 60 is, for example, a circuit including a capacitor, and stores the electric power for driving the control circuit 44 based on the current rectified by the rectifying circuit 50.

In the first embodiment, it is preferred that, as shown at the lower stage of FIG. 6, the electric power be generated during a period in which the permanent magnet 41 is rotated in the forward direction from the rotation angle of 0° to 180° and a period in which the permanent magnet 41 is rotated in the reverse direction from the rotation angle of 0° to −180°. The reason therefor is because, in those periods, the angular velocity of the permanent magnet 41 is fast and thus the counter-electromotive voltage to be detected is large, and hence electric power is likely to be obtained.

### [Outline of Overall Configuration: Rate Adjustment Control]

With reference to FIG. 6, the rate adjustment control in the first embodiment is described.

In the first embodiment, the speed governing pulse output circuit 46 outputs the speed governing pulse so as to control the movement of the permanent magnet 41, thereby controlling the movement of the balance wheel 31 so as to perform the rate adjustment.

In this case, under a state in which the angular velocity of the permanent magnet 41 is fast, it is difficult to perform the rate adjustment at a desired timing. The reason therefor is because, under a state in which the angular velocity of the permanent magnet 41 is fast, it is highly possible that the output timing of the speed governing pulse is deviated. The state in which the angular velocity of the permanent magnet 41 is fast is the time at which a large counter-electromotive voltage is generated in the coil 43, that is, the timing at which the rotation detecting circuit 45 detects the detection signal.

In view of the above, in the first embodiment, it is preferred that the speed governing pulse be output while the permanent magnet 41 is rotated in the reverse direction from the rotation angle of 180° to 0°, and while the permanent magnet 41 is rotated in the forward direction from the rotation angle of −180° to 0° in the forward direction motion and the reverse direction motion in the forward/reverse rotational motion of the permanent magnet 41. That is, it is preferred that the speed governing pulse be output during a period before the balance wheel 31 is supplied with the motive power from the power spring 11. In this manner, the speed governing pulse can be output under a state in which the angular velocity of the permanent magnet 41 is relatively low. It is preferred that the speed governing pulse be output in a period other than the above-mentioned period in which electric power is likely to be generated. That is, it is preferred that the speed governing pulse be output in a period other than the period in which the permanent magnet 41 is rotated in the forward direction from the rotation angle of 0° to 180° and the period in which the permanent magnet 41 is rotated in the reverse direction from the rotation angle of 0° to −180° shown at the lower stage of FIG. 6. When such a configuration is adopted, deviation of the output timing of the speed governing pulse can be suppressed. As a result, the rate accuracy can be maintained. In FIG. 6, the timing to perform the rate adjustment is indicated by a band-shaped region. As shown in the graph at the upper stage of FIG. 6, the rate adjustment is performed during a period in which the angular velocity of the permanent magnet 41 is low.

### [Each Torque Acting on Permanent Magnet]

In a comparative example and the first embodiment described below, a “holding torque” refers to a magnetic attraction force acting between the permanent magnet and the soft magnetic core while the coil 43 is in a de-energized state. The holding torque acts in a direction corresponding to the arrangement or the like of the notches or the welding portions made of a material other than the magnetic material in the soft magnetic core made of a soft magnetic material. Further, a “spring torque” is a torque caused by the elastic deformation of the hairspring. The spring torque is dependent on the above-mentioned Young's modulus. That is, the spring torque becomes larger as the Young's modulus of the hairspring becomes higher, and the spring torque becomes smaller as the Young's modulus becomes lower.

A “friction torque” is a torque that is based on a friction caused at a contact surface between the pallet fork and the escape wheel and pinion. The friction torque counteracts against the spring torque of the hairspring at a position before the position of 0°, when the permanent magnet returns to the position of 0° along with the elastic deformation of the hairspring. A “power spring torque” is a torque that is based on release of accumulated energy of the spring supplied to the balance from the power spring 11 via the wheel train. The power spring torque is a torque acting in an advancing direction when the permanent magnet rotates from the position of 0° to the positions of +340°.

### [Each Torque Acting on Permanent Magnet: Comparative Example]

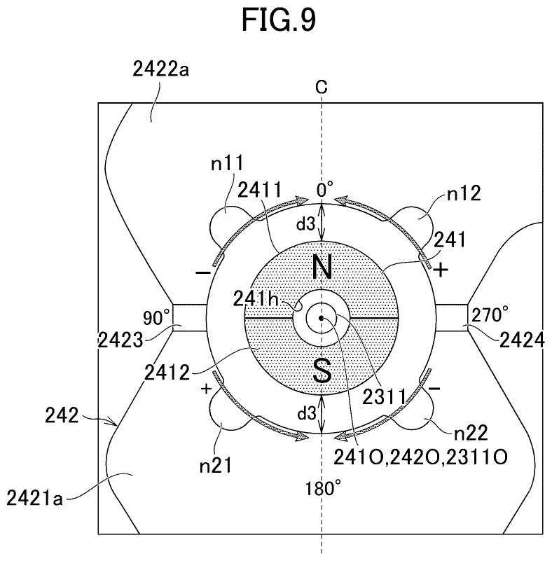

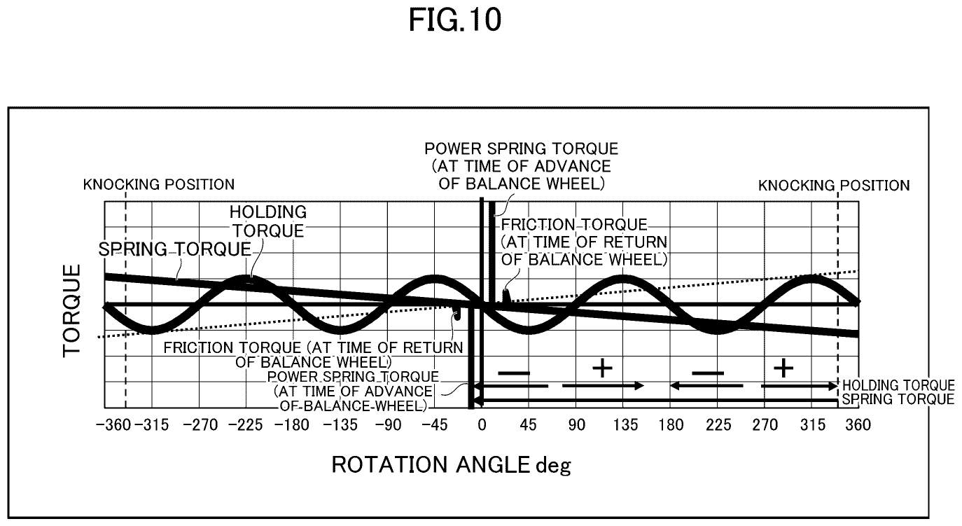

Now, before describing each torque acting on the permanent magnet 41 in the first embodiment, with reference to FIG. 9 and FIG. 10, each torque acting on a permanent magnet 241 in a comparative example is described. FIG. 9 is a plan view for illustrating an arrangement of a permanent magnet, magnetic core, and a balance staff in the comparative example. FIG. 10 is an explanatory graph for showing each torque acting on the permanent magnet in the comparative example. The arrow of FIG. 9 indicates a direction in which the holding torque acts. In the comparative example, configurations having functions similar to those of the first embodiment, such as configurations described with reference to FIG. 3, are denoted by the same reference symbols, and detailed description thereof is omitted.

As illustrated in FIG. 9, the permanent magnet 241 has a circular planar shape. A first end portion 2421a and a second end portion 2422a of a soft magnetic core 242 each have a shape including an inner peripheral surface having a half arc shape, and are arranged so as to be opposed to each other through intermediation of the permanent magnet 241. The first end portion 2421a, the second end portion 2422a, a first welding portion 2423, and a second welding portion 2424 of the soft magnetic core 242 are configured to form a circular opening (hole).

In the comparative example, a center position 2410 of the permanent magnet 241, a center position 2420 of the opening of the soft magnetic core 242, and a rotation center 23110 of a balance staff 2311 inserted through an insertion hole 241h formed at a center portion of the permanent magnet 241 match each other.

FIG. 9 shows the permanent magnet 241 under a state in which the hairspring is brought to its neutral position of elastic deformation. In other words, FIG. 9 shows a state in which the permanent magnet 241 is brought to the position of 0°. Under a state in which the permanent magnet 241 is brought to the position of 0°, an N-pole portion 2411 is arranged on the second end portion 2422a side, and an S-pole portion 2412 is arranged on the first end portion 2421a side.

In this case, for example, when the permanent magnet 241 is rotated from the state illustrated in FIG. 9 in the forward direction (counterclockwise direction of FIG. 9), while the rotation angle is from 0° to 90°, the holding force acts in a direction of returning to 0°. While the rotation angle is from 90° to 180°, the holding force acts in a direction of advancing to 180°. While the rotation angle is from 180° to 270°, the holding force acts in a direction of returning to 180°. While the rotation angle is from 270° to 340°, the holding force acts in a direction of advancing to 340°.

Accordingly, in the comparative example, the permanent magnet 241 has the holding torque of substantially 0 and is magnetically stable at the position of 0° and the position of 180°.

The waveform of FIG. 10 indicates the holding torque in the comparative example. Further, the linear solid line of FIG. 10 indicates the spring torque of the hairspring. The spring torque of the hairspring linearly changes along with the rotation of the permanent magnet 241. For example, when the permanent magnet 241 is rotated in the forward direction from the state of the rotation angle of 0°, the spring torque of the hairspring acting in a direction reverse to the rotation direction of the permanent magnet 41 is linearly increased.

After the permanent magnet 241 returns from the rotation angle of 340° to 0° in accordance with the elastic deformation of the hairspring, the permanent magnet 241 further advances to the rotation angle of −340° due to the power spring torque and the inertia force of the balance wheel 31. Further, the permanent magnet returns to 0° in accordance with the elastic deformation of the hairspring. As described above, the permanent magnet 241 repeats the reciprocating motion between −340° and 340°.

In this case, as described above with reference to FIG. 3, the pallet fork 22 is operated so as to cancel the stopping of the operation of the escape wheel and pinion 21, and thus the operation of the escape wheel and pinion 21 is restarted to drive the hands. The cancelation of the stopping of the operation of the escape wheel and pinion 21 by the pallet fork 22 is performed by causing the impulse jewel 312a rotating together with the balance wheel 31 to collide with the lever portion 222 of the pallet fork 22. When the force of the impulse jewel 312a colliding with the lever portion 222 of the pallet fork 22 is smaller than a friction (static frictional force) caused at the contact surface between the entry pallet 223a or the exit pallet 224a of the pallet fork 22 and the tooth of the escape wheel and pinion 21, the impulse jewel 312a cannot cause the pallet fork 22 to operate. Unless the pallet fork 22 is operated by the collision of the impulse jewel 312a, the operation of the escape wheel and pinion 21 cannot be restarted, and the hands are stopped.

Accordingly, the impulse jewel 312a is required to collide with the lever portion 222 of the pallet fork 22 at an impact force having a certain level of magnitude. In order to increase the impact force of the impulse jewel 312a with respect to the lever portion 222 of the pallet fork 22, it is preferred to increase the spring torque of the hairspring. However, when the spring torque of the hairspring is increased, the low speed oscillation of the balance wheel 31 cannot be achieved. Further, it is conceivable to increase the inertia moment of the balance wheel 31, but, in this case, the angular velocity of the permanent magnet 41 is decreased, and there arises a problem of reduction in power generation amount.

Further, when the balance wheel is temporarily stopped due to an external impact or the like and its inertia force is lost, the rotation of the balance wheel is continued only with the spring torque of the hairspring. In this case, when the spring torque of the hairspring is smaller than the holding torque, there is a possibility that the rotation of the balance wheel stops in the middle.

Particularly in the comparative example, the balance wheel (permanent magnet) is liable to be stopped at the position of 180° which is a magnetic stable point. The dotted line of FIG. 10 indicates a straight line obtained by folding back the straight line indicating the spring torque with respect to the horizontal axis. When this dotted line is smaller than the holding torque, there is a possibility that the balance wheel is stopped. In the example of FIG. 10, for example, when the inertia force of the balance wheel is lost in the vicinity of the position of 135°, because the holding torque is larger than the spring torque, the permanent magnet is stopped at the position of 180° due to the influence of the holding torque.

In view of the above, in the first embodiment, there is adopted a configuration in which the tendency of the holding torque is changed from the tendency shown in the comparative example so that the spring torque of the hairspring 32 can be decreased and the rotation of the balance wheel 31 can be stably continued.

### Each Torque Acting on Permanent Magnet: First Embodiment

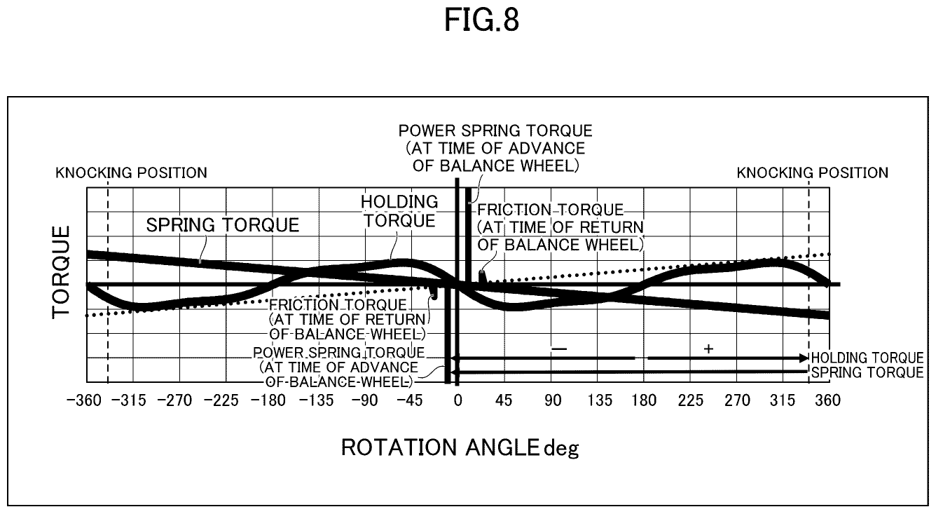

With reference to FIG. 7A, FIG. 7B, and FIG. 8, each torque acting on the permanent magnet 41 in the first embodiment is described. FIG. 7A and FIG. 7B are plan views for illustrating the arrangement of the permanent magnet, the soft magnetic core, and the balance staff in the first embodiment. FIG. 7A shows a state in which the permanent magnet is brought to the position of 0° which is a first angle position, and FIG. 7B shows a state in which the permanent magnet is brought to the position of 180° which is a second angle position. FIG. 8 is an explanatory graph for showing each torque acting on the permanent magnet in the first embodiment. The arrows of FIG. 7A and FIG. 7B indicate the direction in which the holding torque acts.

The waveform of FIG. 8 indicates the holding torque in the first embodiment. Further, the linear solid line of FIG. 8 indicates the spring torque of the hairspring 32. The spring torque of the hairspring 32 linearly changes along with the rotation of the permanent magnet 41. For example, when the permanent magnet 41 is rotated in the forward direction from the rotation angle of 0°, the spring torque of the hairspring 32 acting in a direction reverse to the rotation direction of the permanent magnet 41 is linearly increased.

The holding torque shown in FIG. 8 has a waveform in which the holding torque acts in the reverse direction (clockwise direction) when the rotation angle of the permanent magnet 41 is from 0° to 180°, and the holding torque acts in the forward direction (counterclockwise direction) when the rotation angle is from 180° to 340°. That is, while the rotation angle is from 0° to 340°, the nodes of the waveform indicating the holding torque are only at the position of 0° and the position of 180°.

Accordingly, when the permanent magnet 41 is rotated in the forward direction from the position of 0°, the holding torque acts in the direction of returning the rotation while the rotation angle is from 0° to 180°, and the holding torque acts in the direction of advancing the rotation while the rotation angle is from 180° to 340°.

Further, when the permanent magnet 41 is rotated in the reverse direction from the position of 340°, the holding torque acts in the direction of returning the rotation while the rotation angle is from 340° to 180°, and the holding torque acts in the direction of advancing the rotation while the rotation angle is from 180° to 0°.

Further, the holding torque shown in FIG. 8 has a waveform in which the holding torque acts in the forward direction (counterclockwise direction) when the rotation angle of the permanent magnet 41 is from 0° to −180°, and the holding torque acts in the reverse direction (clockwise direction) when the rotation angle is from −180° to −340°. That is, while the rotation angle is from 0° to −340°, the nodes of the waveform indicating the holding torque are only at the position of 0° and the position of −180°.

Accordingly, when the permanent magnet 41 is rotated in the reverse direction from the position of 0°, the holding torque acts in the direction of returning the rotation while the rotation angle is from 0° to −180°, and the holding torque acts in the direction of advancing the rotation while the rotation angle is from −180° to −340°.

Further, when the permanent magnet 41 is rotated in the forward direction from the position of −340°, the holding torque acts in the direction of returning the rotation while the rotation angle is from −340° to −180°, and the holding torque acts in the direction of advancing the rotation while the rotation angle is from −180° to 0°.

Accordingly, in the first embodiment, the permanent magnet 41 has the holding torque of substantially 0 and is magnetically stable at the position of 0°.

In the first embodiment, from positions of +180° before the permanent magnet 41 returns to the position of 0°, the holding torque acts in the same direction as the spring torque, that is, the direction of advancing the rotation. That is, under a state in which the coil 43 is brought to a de-energized state and the permanent magnet 41 is present between the position of 0° and the position of +180°, the holding torque acting in the direction of rotating the permanent magnet 41 toward the position of 0° always acts between the permanent magnet 41 and the soft magnetic core 42. Because such a holding torque acts, the permanent magnet 41 returns to the position of 0° with great force. Accordingly, the impulse jewel 312a collides with the lever portion 222 of the pallet fork 22 with great force. With the action of the holding torque having a tendency shown in FIG. 8, even when the spring torque of the hairspring 32 is decreased, the pallet fork 22 and the escape wheel and pinion 21 are easily operated. Accordingly, the spring torque of the hairspring 32 can be decreased so that the low speed oscillation is achieved, and the rotation of the balance wheel 31 can be stably continued.

Further, with the action of the holding torque having a tendency shown in FIG. 8, for example, even when the inertia force of the balance wheel 31 is lost in the vicinity of the position of 135° due to an external impact or the like, the balance wheel 31 is rotated toward the position of 0° by, in addition to the spring torque, the holding torque acting in the same direction as the spring torque. Accordingly, even when the inertia force is lost, the balance wheel 31 can return to the position of 0° with a certain level of force, and the impulse jewel 312a collides with the lever portion 222 of the pallet fork 22 with a certain level of force.

Further, in the first embodiment, from −180° to 0°, the holding torque can be caused to effectively act in the direction in which the permanent magnet 41 advances, and the angular velocity of the permanent magnet 41 can be increased. As a result, the power generation efficiency can be increased.

### [Arrangement of Permanent Magnet, Soft Magnetic Core, and Balance Staff]

Further, details of the arrangement of the permanent magnet 41, the soft magnetic core 42, and the balance staff 311 for achieving the waveform of the holding torque shown in FIG. 8 are described.

As illustrated in FIG. 7A and FIG. 7B, the permanent magnet 41 has a circular planar shape. More specifically, the planar shape of the permanent magnet 41 is a true circle in which a distance from its center position 410 to its outer peripheral surface is equal at any position in the circumferential direction.

The first end portion 421a and the second end portion 422a of the soft magnetic core 42 each have a shape including the inner peripheral surface (inner peripheral surface 421a1 and inner peripheral surface 422a1) having a half arc shape, and are arranged so as to be opposed to each other through intermediation of the permanent magnet 41. The first end portion 421a, the second end portion 422a, the first welding portion 423, and the second welding portion 424 of the soft magnetic core 42 are configured to form a circular opening. More specifically, an inner peripheral surface of the opening formed by the soft magnetic core 42 is a true circle in which a distance from its center position 420 is equal at any position in the circumferential direction. The inner peripheral surface of the opening formed by the soft magnetic core 42 described here means an inner peripheral surface excluding parts in which the notches are formed.

FIG. 7A shows the permanent magnet 41 under a state in which the hairspring 32 is brought to its neutral position of elastic deformation. In other words, FIG. 7A shows a state in which the permanent magnet 41 is brought to the position of 0°. Under a state in which the permanent magnet 41 is brought to the position of 0°, the N-pole portion 411 is arranged on the second end portion 422a side, and the S-pole portion 412 is arranged on the first end portion 421a side. Further, it is preferred that the permanent magnet 41 be arranged so that, under a state in which the permanent magnet 41 is brought to the position of 0°, a boundary line between the N-pole portion 411 and the S-pole portion 412 overlaps an imaginary band-shaped region connecting the first welding portion 423 and the second welding portion 424 to each other. With such a configuration, under a state in which the permanent magnet 41 is brought to the position of 0°, the permanent magnet 41 is magnetically stabilized.

In the first embodiment, as illustrated in FIG. 7A, the center position 410 of the permanent magnet 41 at the position of 0° is arranged so as to be shifted from a rotation center 3110 of the balance staff 311, and the center position 420 of the opening of the soft magnetic core 42 is arranged so as to be shifted from the rotation center 3110 of the balance staff 311. That is, the center position 410 of the permanent magnet 41 is arranged at a position different from the rotation center 3110 of the balance staff 311, and the center position 420 of the opening of the soft magnetic core 42 is arranged at a position different from the rotation center 3110 of the balance staff 311.

Further, the center position 410 of the permanent magnet 41 at the position of 0° is arranged at a position symmetrical with the center position 420 of the opening of the soft magnetic core 42 with respect to the rotation center 3110 of the balance staff 311. Further, a shift amount of the center position 410 with respect to the rotation center 3110 is represented by s1, a shift amount of the center position 420 with respect to the rotation center 3110 is represented by s2, and s1 and s2 are set to be the same.

Further, under a state in which the permanent magnet 41 is brought to the position of 0°, the center position 410 of the permanent magnet 41, the rotation center 3110 of the balance staff 311, and the center position 420 of the opening of the soft magnetic core 42 are arranged side by side on a straight line C orthogonal to the boundary line between the N-pole portion 411 and the S-pole portion 412.

In FIG. 7A, the center position 410 of the permanent magnet 41 is indicated by the black dot, the center position 420 of the opening of the soft magnetic core 42 is indicated by the white circle, and the rotation center 3110 of the balance staff 311 is indicated by the black dot. The black dots and the white circle in the figure are shown for the sake of easy description, and are not physically present.

Further, the long-dashed double-short dashed line of FIG. 7A indicates a line that is parallel to the boundary line between the N-pole portion 411 and the S-pole portion 412 and passes through the center position 410 of the permanent magnet 41. The broken line of FIG. 7A indicates a line that is parallel to the boundary line between the N-pole portion 411 and the S-pole portion 412 and passes through the center position 420 of the opening of the soft magnetic core 42. The solid line of FIG. 7A indicates a line that is parallel to the boundary line between the N-pole portion 411 and the S-pole portion 412 and passes through the rotation center 3110 of the balance staff 311.

An interval d1 which is a second interval between the outer peripheral surface of the N-pole portion 411 of the permanent magnet 41 at the position of 0° and the inner peripheral surface 422a1 of the second end portion 422a is relatively small. Meanwhile, an interval d2 (>d1) which is a first interval between the outer peripheral surface of the S-pole portion 412 of the permanent magnet 41 at the position of 0° and the inner peripheral surface 421a1 of the first end portion 421a is relatively large. The interval d1 illustrated in FIG. 7A is an interval at a position at which the permanent magnet 41 at the position of 0° and the second end portion 422a are closest to each other in the radial direction. The interval d2 illustrated in FIG. 7A is an interval at a position at which the permanent magnet 41 at the position of 0° and the first end portion 421a are farthest from each other in the radial direction. With such an arrangement configuration, a relatively large holding torque acts on the permanent magnet 41 in a direction toward the position of 0°.

FIG. 7B shows a state in which the permanent magnet 41 is rotated by 180° in the forward direction from the state illustrated in FIG. 7A. As illustrated in FIG. 7B, under a state in which the permanent magnet 41 is brought to the position of 180°, the center position 410 of the permanent magnet 41 and the center position 420 of the opening of the soft magnetic core 42 match each other. Accordingly, an interval between the outer peripheral surface of the permanent magnet 41 and the inner peripheral surface of the soft magnetic core 42 becomes uniform in the circumferential direction. That is, at the position of 180°, the S-pole portion 412 is arranged so as to be opposed to the second end portion 422a with an interval d4 which is a third interval, and the N-pole portion 411 is arranged so as to be opposed to the first end portion 421a with an interval d3 which is a fourth interval. The interval d4 and the interval d3 are equal to each other.

The interval d3 and the interval d4 are larger than the interval d1 and smaller than the interval d2. With such an arrangement configuration, a relatively small holding torque acts on the permanent magnet 41 in a direction toward the position of 180°. The interval d3 and the interval d4 are not always required to be the same, and it is preferred that a difference between the interval d3 and the interval d4 at least be smaller than a difference between the interval d1 and the interval d2.

In the first embodiment, the shift amounts s1 and s2 are set so that the holding torque that tends to become stable at the position of 0° becomes sufficiently larger than the holding torque that tends to become stable at the position of 180°. That is, the shift amounts s1 and s2 are set so that the holding torque becomes stable at the position of 0° and becomes unstable at the position of 180°. In this manner, the waveform of the holding torque shown in FIG. 8 can be achieved.

In the first embodiment, description has been given of an example in which the holding torque acts in the direction of advancing the rotation from the positions of +180° before the permanent magnet 41 returns to the position of 0°, but the present invention is not limited thereto. It is preferred that the shift amounts s1 and s2 be set so that the holding torque acts in the direction of advancing the rotation at least from the positions of +135° before the permanent magnet 41 returns to the position of 0°.

Further, in FIG. 7A, the interval d1 indicates the interval at the position at which the outer peripheral surface of the N-pole portion 411 of the permanent magnet 41 and the inner peripheral surface 422al of the second end portion 422a of the soft magnetic core 42 are closest to each other, and the interval d2 indicates the interval at the position at which the outer peripheral surface of the S-pole portion 412 of the permanent magnet 41 and the inner peripheral surface 421al of the first end portion 421a of the soft magnetic core 42 are farthest from each other, but the present invention is not limited thereto.

It is preferred that the interval d1 be an interval between the N-pole portion 411 and the second end portion 422a on a normal to the outer peripheral surface of the N-pole portion 411 in plan view, at any position in the circumferential direction of the N-pole portion 411. It is preferred that the interval d2 be an interval between the S-pole portion 412 and the first end portion 421a on a normal to the outer peripheral surface of the S-pole portion 412 in plan view, at any position in the circumferential direction of the S-pole portion 412.

In the first embodiment, when the permanent magnet 41 is brought to the position of 0°, at any position in the circumferential direction of the permanent magnet 41, the interval d1 between the outer peripheral surface of the N-pole portion 411 and the inner peripheral surface 422al of the second end portion 422a is narrower than the interval d2 between the outer peripheral surface of the S-pole portion 412 and the inner peripheral surface 421a1 of the first end portion 421a. Accordingly, at any position in the circumferential direction of the permanent magnet 41, a difference between the interval d1 between the outer peripheral surface of the N-pole portion 411 and the inner peripheral surface 422al of the second end portion 422a and the interval d2 between the outer peripheral surface of the S-pole portion 412 and the inner peripheral surface 421al of the first end portion 421a is larger than 0. Meanwhile, as described above, when the permanent magnet 41 is brought to the position of 180°, at any two positions in the circumferential direction of the permanent magnet 41, a difference in interval between the outer peripheral surface of the permanent magnet 41 and the inner peripheral surface of the opening of the soft magnetic core 42 is 0. That is, in the configuration of the first embodiment, the difference between the interval between the N-pole portion 411 and the soft magnetic core 42 and the interval between the S-pole portion 412 and the soft magnetic core 42 is smaller in the case in which the permanent magnet 41 is brought to the position of 180° than the case in which the permanent magnet 41 is brought to the position of 0°.

When the configuration described above is adopted, the holding torque achieves the tendency shown in FIG. 8.

Accordingly, the spring torque of the hairspring 32 can be decreased, and the rotation of the balance wheel 31 can be stably continued.

### [Eccentric Structure]

Next, with reference to FIG. 11 to FIG. 18C, details of an eccentric structure for achieving the arrangement configuration illustrated in FIG. 7A and FIG. 7B are described.

### [Eccentric Structure: Decentering of Permanent Magnet 41]

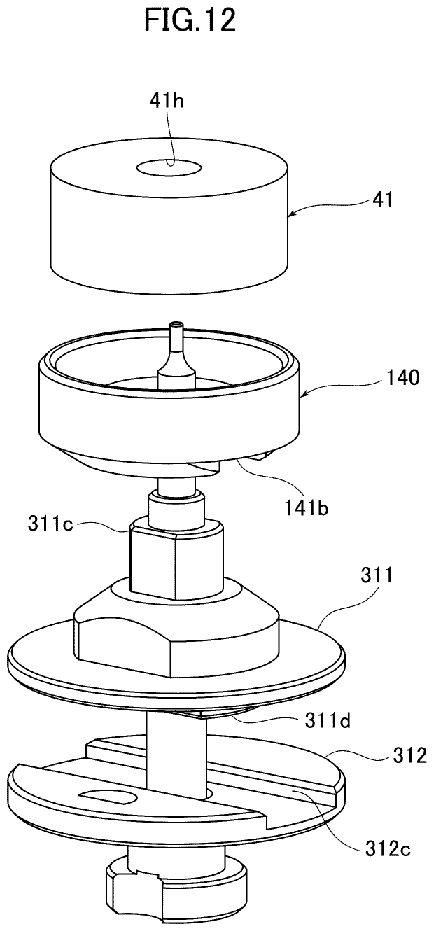

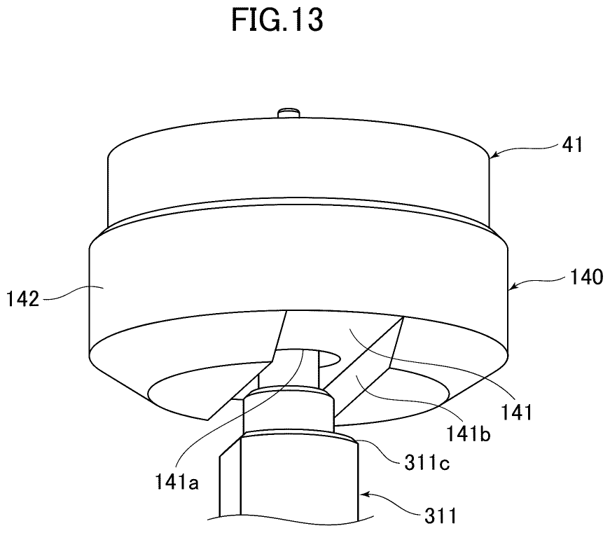

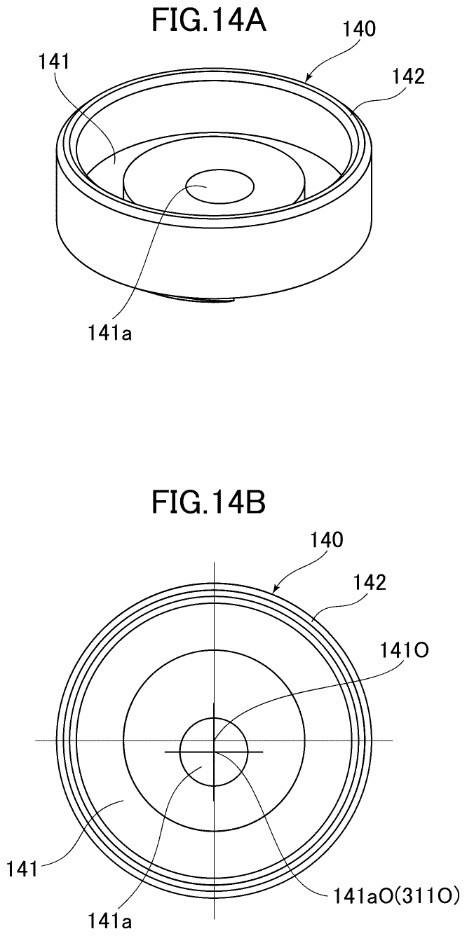

FIG. 11 is a perspective view for illustrating members rotating together with the balance staff in the first embodiment. FIG. 12 is an exploded perspective view for illustrating the members illustrated in FIG. 11 in a disassembled manner. FIG. 13 is a perspective view for illustrating a bottom portion of a holding member in the first embodiment. FIG. 14A is a perspective view for illustrating the holding member in the first embodiment. FIG. 14B is a plan view for illustrating the holding member in the first embodiment. FIG. 15 is an exploded perspective view for illustrating the balance staff and the roller table in a disassembled manner.

As illustrated in FIG. 11 and FIG. 12, the permanent magnet 41 is held by a holding member 140 by being accommodated in the holding member 140. The holding member 140 includes, as illustrated in FIG. 14A and FIG. 14B, a bottom portion 141 having a circular planar shape, and a cylindrical side wall portion 142 rising from the bottom portion 141. An inner diameter of the side wall portion 142 is substantially the same as an outer diameter of the permanent magnet 41, and the permanent magnet 41 is press-fitted into the side wall portion 142 so as to be rotated integrally with the holding member 140.

In the bottom portion 141, an insertion hole 141a through which the balance staff 311 is to be inserted is formed. Further, in a lower surface of the bottom portion 141, a positioning groove 141b is formed as illustrated in FIG. 13.

The balance staff 311 includes a fitting portion 311c to be fitted to the positioning groove 141b under a state in which the balance staff 311 is inserted through the insertion hole 141a of the bottom portion 141. When the fitting portion 311c is fitted to the positioning groove 141b, the rotation center 3110 of the balance staff 311 is positioned with respect to the center position 410 of the permanent magnet 41, and the holding member 140 is rotated integrally with the balance staff 311.

A center position 141a0 of the insertion hole 141a matches the rotation center 3110 of the balance staff 311. As illustrated in FIG. 14B, the center position 141a0 of the insertion hole 141a is formed so as to be shifted from a center position 1410 of the circular bottom portion 141. Accordingly, the center position 410 of the permanent magnet 41 accommodated in the holding member 140 is arranged so as to be shifted from the rotation center 3110 of the balance staff 311 inserted through the insertion hole 141a.

Further, the balance wheel 31 includes the roller table 312 at its center portion. The impulse jewel 312a is fixed to the roller table 312. The roller table 312 includes, as illustrated in FIG. 15, an insertion hole 312b through which the balance staff 311 is to be inserted, and a positioning groove 312c to which the fitting portion 311d of the balance staff 311 is to be fitted. With such a configuration, the impulse jewel 312a is positioned with respect to the rotation center 3110 of the balance staff 311, and the impulse jewel 312a is rotated along with the rotation of the balance wheel 31.

### [Eccentric Structure: Decentering of Soft Magnetic Core 42]

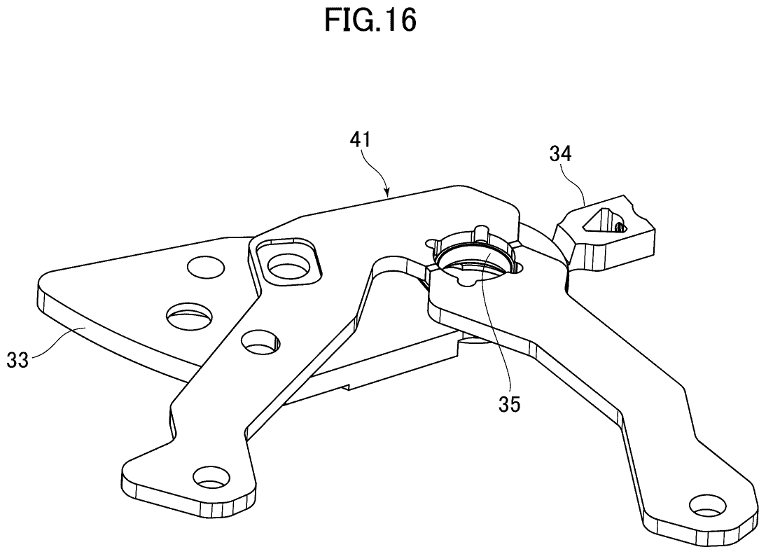

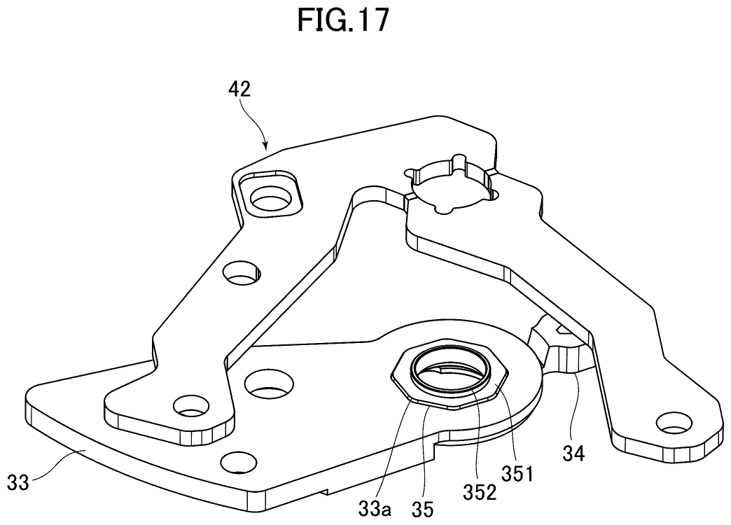

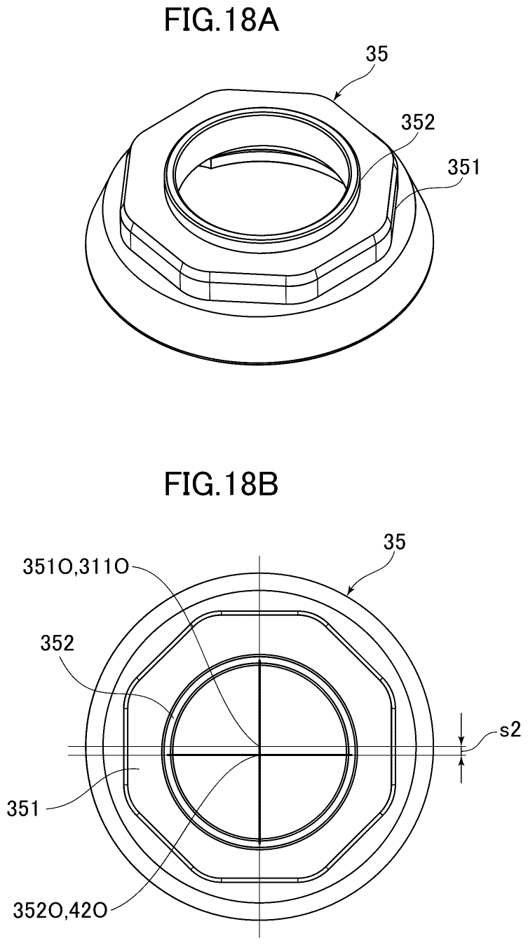

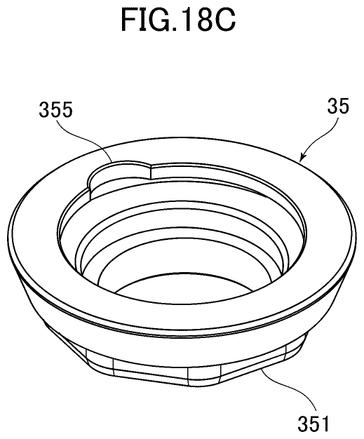

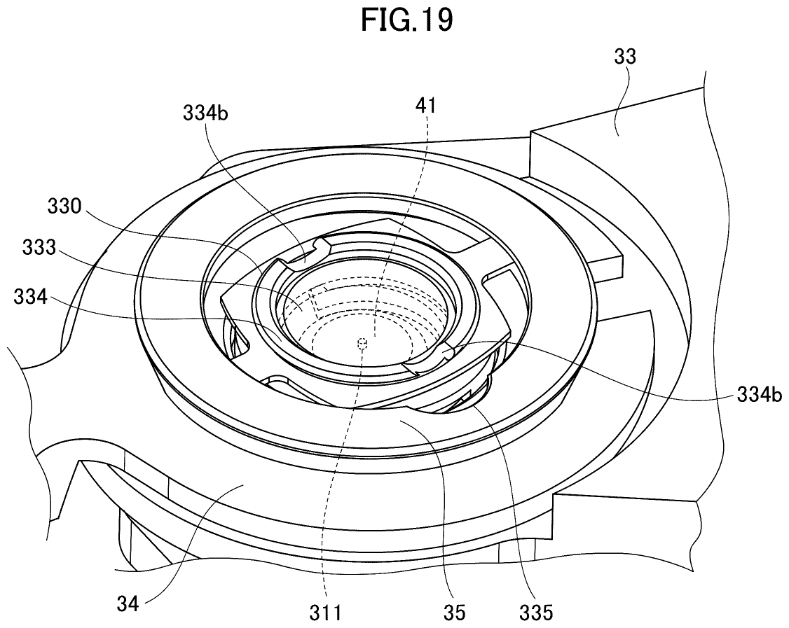

FIG. 16 is a perspective view for illustrating the soft magnetic core and its surrounding members in the first embodiment. FIG. 17 is an exploded perspective view for illustrating the soft magnetic core illustrated in FIG. 16 which is disassembled from a support member. FIG. 18A is a perspective view for illustrating a positioning frame in the first embodiment. FIG. 18B is a plan view for illustrating the positioning frame in the first embodiment. FIG. 18C is a perspective view for illustrating the positioning frame in the first embodiment.

The soft magnetic core 42 is supported by a support member 33. Further, the support member 33 is fixed to the main plate 10. That is, the soft magnetic core 42 is fixed with respect to the main plate 10 through intermediation of the support member 33. In the support member 33, an opening 33a corresponding to the opening of the soft magnetic core 42 is formed.

The mechanical timepiece 1 includes a positioning frame 35 which is mounted to the support member 33 and is configured to position the soft magnetic core 42 with respect to the support member 33. The positioning frame 35 has a shape including, as illustrated in FIG. 18A, a fitting portion 351 and an annular projection 352 which is a positioning projection.

As illustrated in FIG. 18B, the fitting portion 351 has an octagonal planar shape. The positioning frame 35 is positioned with respect to the support member 33 when the fitting portion 351 is fitted to the opening 33a of the support member 33. The planar shape of the fitting portion 351 is not limited to an octagon, and is only required to be a shape that is fitted to the opening 33a and restricts the displacement in the circumferential direction.

The annular projection 352 is fitted to the opening of the soft magnetic core 42 so that the soft magnetic core 42 is positioned.

In this case, as illustrated in FIG. 18B, a center position 3520 of the annular projection 352 is arranged so as to be shifted from a center position 3510 of the fitting portion 351. The center position 3510 of the fitting portion 351 is arranged so as to match the rotation center 3110 of the balance staff 311. The center position 3520 of the annular projection 352 is arranged so as to match the center position 420 of the opening of the soft magnetic core 42. The center position 3510 of the fitting portion 351 matches a center position of an outer shape of the positioning frame 35.

With such a configuration, the center position 420 of the opening of the soft magnetic core 42 is arranged so as to be shifted from the rotation center 3110 of the balance staff 311. In this case, as illustrated in FIG. 7A, the center position 420 of the opening of the soft magnetic core 42 is required to be arranged at a position symmetrical with the center position 410 of the permanent magnet 41 at the position of 0° with respect to the rotation center 3110 of the balance staff 311. However, under a state in which the soft magnetic core 42 and the support member 33 are assembled to each other as illustrated in FIG. 16, it is difficult to determine the position of the positioning frame 35 in the circumferential direction.

In view of the above, in the first embodiment, as illustrated in FIG. 18C, a cutout 355 is formed on an opposite side in a protruding direction of the fitting portion 351 and the annular projection 352. At the time of positioning the positioning frame 35 in the circumferential direction, a person who produces the mechanical timepiece 1 can perform the positioning while viewing the cutout 355 so that the cutout 355 is arranged at a predetermined position in the circumferential direction. In place of the cutout 355, a visible mark or the like may be provided.

### [Bearing Structure]

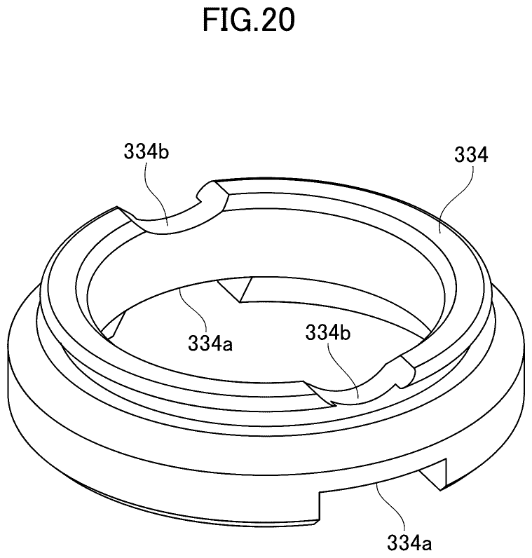

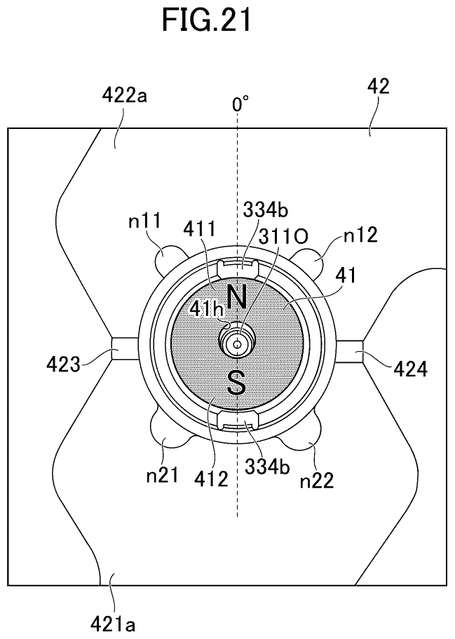

Next, with reference to FIG. 19 to FIG. 21, a bearing structure in the first embodiment is described. FIG. 19 is a perspective view for illustrating the bearing structure and its surrounding members in the first embodiment. FIG. 20 is a perspective view for illustrating a cap jewel holding member in the first embodiment. FIG. 21 is a plan view for illustrating the cap jewel holding member and its surrounding members in the first embodiment. In FIG. 21, illustration of the positioning frame 35, a cap jewel 333, and the like is omitted.

As illustrated in FIG. 19, a bearing structural body 330 is arranged on the inner side of the above-mentioned positioning frame 35. The bearing structural body 330 is a structural body for supporting one end of the balance staff 311.

The bearing structural body 330 at least includes the cap jewel 333 and a cap jewel holding member 334 for holding the cap jewel 333. The cap jewel 333 abuts against one end of the balance staff 311 to perform positioning of the balance staff 311 in an axial direction. The cap jewel holding member 334 is an annular member surrounding at least a part of the outer peripheral surface of the permanent magnet 41.

In the first embodiment, the cap jewel holding member 334 is formed of a magnetic material such as carbon tool steel (SK material) containing carbon.

Further, in the first embodiment, as illustrated in FIG. 20, a cutout 334a is formed in a part of the cap jewel holding member 334. Specifically, the cutout 334a is formed in a part of a portion of the cap jewel holding member 334 to be opposed to the outer peripheral surface of the permanent magnet 41.

When such a cap jewel holding member 334 is adopted, the flow of the magnetic fluxes caused around the permanent magnet 41 can be changed. As a result, the holding torque acting on the permanent magnet 41 can be affected. The holding torque is affected by a principle similar to that of the notches n11, n12, n21, and n22 formed in the soft magnetic core 42. That is, the holding torque is affected because a part of the cap jewel holding member 334 in which the magnetic material is present and a part thereof in which the magnetic material is absent (cutout 334a) are arranged so as to be opposed to the outer peripheral surface of the permanent magnet 41.

Further, in the holding member 334, a cutout 334b is formed at a position that is on a side opposite to the side on which the cutout 334a is formed, and corresponds to the cutout 334a in the circumferential direction. FIG. 21 shows an example in which, in plan view, the cutout 334b is formed at each of positions opposed to the N-pole portion 411 and the S-pole portion 412 of the permanent magnet 41 at the position of 0°. That is, in FIG. 21, the cutout 334a is formed at each of the positions opposed to the N-pole portion 411 and the S-pole portion 412 of the permanent magnet 41 at the position of 0°.

The cap jewel holding member 334 is provided so as to be rotatable in the rotation direction of the permanent magnet 41 from the state of FIG. 21, and can change the position of the cutout 334a depending on its angle position. In the first embodiment, the holding torque can be finely adjusted in accordance with the position of the cutout 334a. At the time of adjusting the angle position of the cap jewel holding member 334, the person who produces the mechanical timepiece 1 can perform the adjustment while viewing the cutout 334b so that the cutout 334a is arranged at a predetermined position in the circumferential direction. In place of the cutout 334b, a visible mark or the like may be provided.

When such a configuration in which the holding torque is finely adjustable through use of the cap jewel holding member 334 made of the magnetic material is adopted, an error of the holding torque that may be caused by an individual difference can be suppressed.

FIG. 20 shows an example in which the cutout 334a is formed in two portions, but the present invention is not limited thereto. The cutout 334a may be formed in one portion, or may be formed in three or more portions.

### Modification Examples

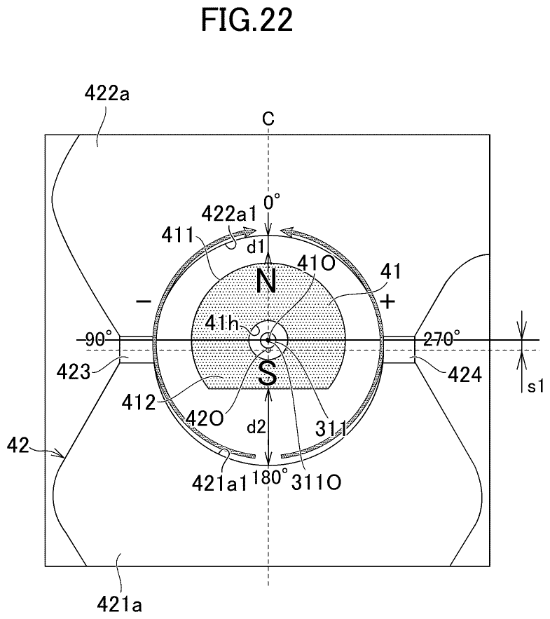

Next, with reference to FIG. 22 to FIG. 24, modification examples of the first embodiment are described. The tendency of the holding torque described in the first embodiment can be achieved even with the configurations of the respective modification examples described below. That is, the holding torque shown in FIG. 8 can be obtained as long as there is employed a configuration in which the interval d1 which is the second interval is smaller than the interval d2 which is the first interval, and the difference between the interval d4 which is the third interval and the interval d3 which is the fourth interval is smaller than the difference between the interval d2 and the interval d1. In the modification examples, configurations having functions similar to those of the configurations of the first embodiment are denoted by the same reference symbols, and detailed description thereof is omitted. FIG. 22 to FIG. 24 show examples in which no notch is formed in the soft magnetic core 42, but notches may be formed similarly to the configuration illustrated in FIG. 7A.

### First Modification Example

FIG. 22 is a plan view for illustrating the arrangement of the permanent magnet, the soft magnetic core, and the balance staff in a first modification example of the first embodiment. In the first modification example, the planar shape of the permanent magnet 41 is formed into a shape obtained by cutting out a part of a true circle. Specifically, the permanent magnet 41 has a shape in which a part of the S-pole portion 412 is cut out. When such a configuration is adopted, at the position of 0°, the interval d1 between the N-pole portion 411 and the second end portion 422a becomes smaller than the interval d2 between the S-pole portion 412 and the first end portion 421a.

Further, in the first modification example, the center position 410 of the permanent magnet 41 at the position of 0° and the rotation center 3110 of the balance staff 311 are arranged so as to match each other, and the center position 420 of the soft magnetic core 42 is arranged so as to be shifted from the rotation center 3110 of the balance staff 311. Further, the shift amount of the center position 420 of the soft magnetic core 42 with respect to the rotation center 3110 of the balance staff 311 is represented by s1.

With such a configuration, under a state in which the permanent magnet 41 is rotated by 180° in the forward direction from the state illustrated in FIG. 22, the difference between the interval d4 between the S-pole portion 412 and the second end portion 422a and the interval d3 between the N-pole portion 411 and the first end portion 421a becomes smaller than the difference between the interval d2 and the interval d1.

### Second Modification Example

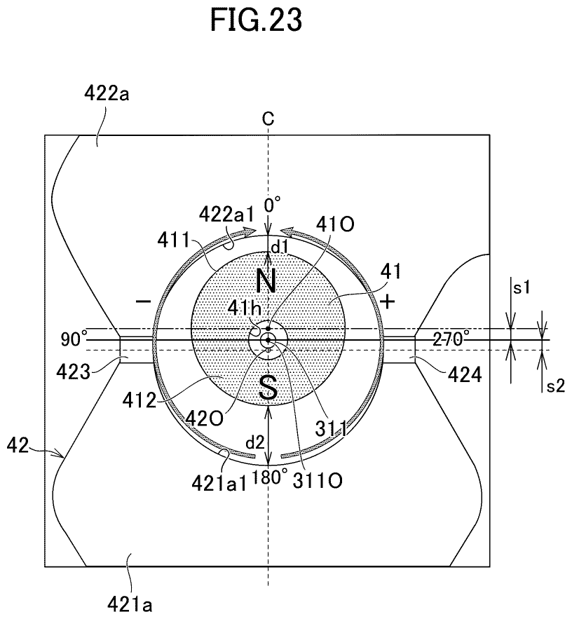

FIG. 23 is a plan view for illustrating the arrangement of the permanent magnet, the soft magnetic core, and the balance staff in a second modification example of the first embodiment.

The second modification example has a configuration in which the center position of the insertion hole 41h which is formed at a center portion of the permanent magnet 41 and through which the balance staff 311 is inserted matches the rotation center 3110 of the balance staff 311. The configuration of the second modification example is similar to that of the first embodiment except that the position of the insertion hole 41h formed at the center portion of the permanent magnet 41 is different. That is, the positional relationship among the center position 410 of the permanent magnet 41, the center position 420 of the opening of the soft magnetic core 42, and the rotation center 3110 of the balance staff 311 is similar to that of the first embodiment.

### Third Modification Example

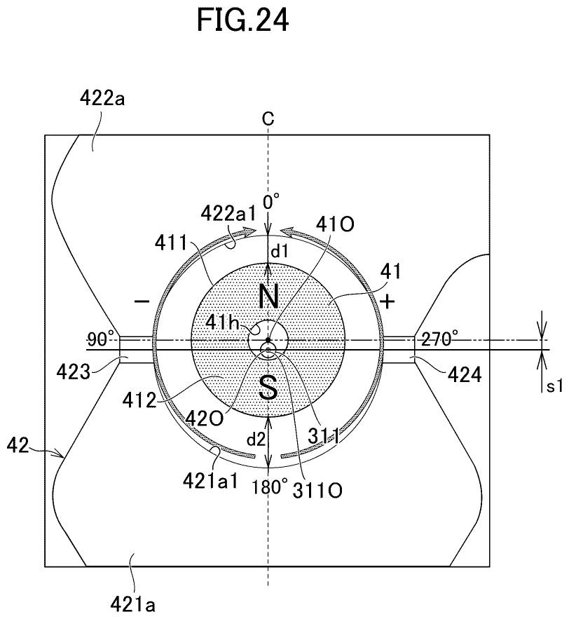

FIG. 24 is a plan view for illustrating the arrangement of the permanent magnet, the soft magnetic core, and the balance staff in a third modification example of the first embodiment.

In the third modification example, under a state in which the permanent magnet 41 is brought to the position of 0°, the center position 420 of the opening of the soft magnetic core 42 and the rotation center 3110 of the balance staff 311 are arranged so as to match each other, and the center position 410 of the permanent magnet 41 is arranged so as to be shifted from the rotation center 3110 of the balance staff 311. In addition, in the third modification example, the opening of the soft magnetic core 42 has an elliptical planar shape. Specifically, a half arc formed by the first end portion 421a is larger than a half arc formed by the second end portion 422a. Further, the shift amount of the center position 410 of the permanent magnet 41 with respect to the rotation center 3110 of the balance staff 311 is represented by s1.

With such a configuration, under a state in which the permanent magnet 41 is rotated by 180° in the forward direction from the state illustrated in FIG. 24, the difference between the interval d4 between N-pole portion 411 and the first end portion 421a and the interval d3 between the S-pole portion 412 and the second end portion 422a becomes smaller than the difference between the interval d2 and the interval d1.

### Second Embodiment

Next, a mechanical timepiece according to a second embodiment of the present invention is described. In the mechanical timepiece according to the second embodiment, its overall configuration is similar to the configuration illustrated in FIG. 1, FIG. 5, and the like, and the eccentric structure is also similar to that in the configuration illustrated in FIG. 7A, FIG. 7B, FIG. 11 to FIG. 15, and the like. Accordingly, configurations having functions similar to those of the first embodiment are denoted by the same reference symbols, and detailed description thereof is omitted.

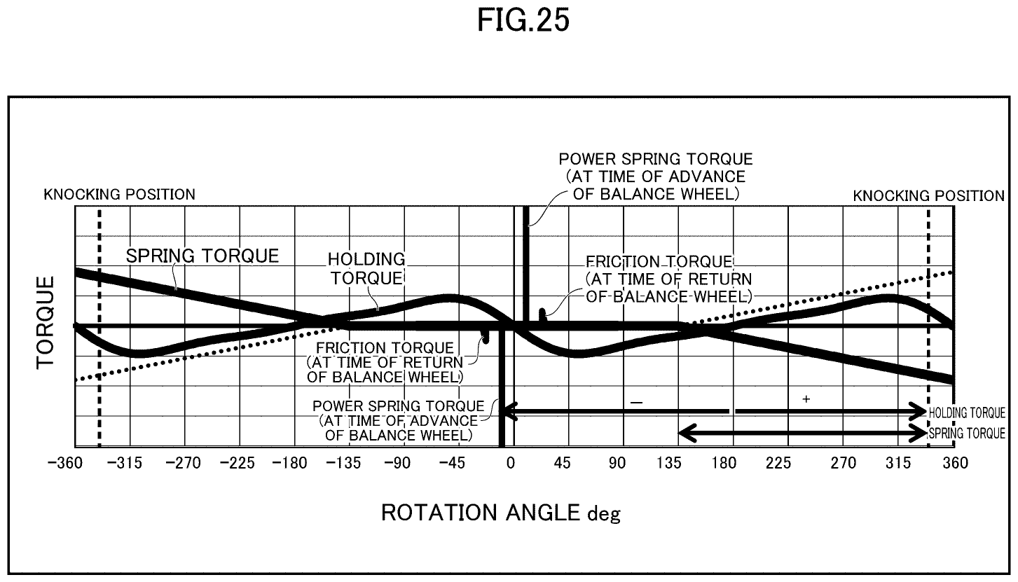

FIG. 25 is an explanatory graph for showing each torque acting on the permanent magnet in the second embodiment. The power spring torque and the friction torque of FIG. 25 are similar to those described with reference to FIG. 8, and hence detailed description thereof is omitted.

One of the thick solid lines of FIG. 25 indicates the holding torque in the second embodiment. Further, another one of the thick solid lines of FIG. 25 indicates a spring torque of a hairspring 232 in the second embodiment. Further, the dotted line of FIG. 25 indicates a line obtained by folding back the line indicating the spring torque in the second embodiment with respect to the horizontal axis.

In the second embodiment, the forward/reverse rotational motion of the balance wheel 31 (balance staff 311) includes at least a period in which the balance wheel 31 (balance staff 311) idly rotates with respect to the hairspring 232 and a period in which the balance wheel 31 (balance staff 311) transmits a rotational force to the hairspring 232 and elastically deforms the hairspring 232. In other words, the spring torque of the hairspring 232 includes a period in which the spring torque linearly changes along with the rotation of the permanent magnet 41 (balance staff 311) and a period in which the spring torque does not change. Specifically, the spring torque of the hairspring 232 is 0 in a period in which the rotation angle of the permanent magnet 41 is from 0° to 135°, and the spring torque of the hairspring 232 acting in the direction opposite to the rotation direction of the permanent magnet 41 linearly increases at 135° and the subsequent angles. After the rotation angle of the permanent magnet 41 reaches 345°, the permanent magnet 41 (balance wheel 31) is rotated in the direction of returning to the rotation angle of 0° in accordance with the elastic deformation of the hairspring 232.

Similarly, the spring torque of the hairspring 232 is 0 in a period in which the rotation angle of the permanent magnet 41 is from 0° to −135°, and the spring torque of the hairspring 232 acting in the direction opposite to the rotation direction of the permanent magnet 41 linearly increases at −135° and the subsequent angles. After the rotation angle of the permanent magnet 41 reaches −345°, the permanent magnet 41 (balance wheel 31) is rotated in the direction of returning to the rotation angle of 0° in accordance with the elastic deformation of the hairspring 232.

As described above, in the second embodiment, there is a period in which the spring torque of the hairspring 232 does not act, and thus further lower speed oscillation as compared to the first embodiment can be achieved. Further, in the second embodiment, the eccentric structure is adopted similarly to the first embodiment, and hence the spring torque of the hairspring 232 can be decreased, and the rotation of the balance wheel 31 can be stably continued by receiving the action of the holding torque.

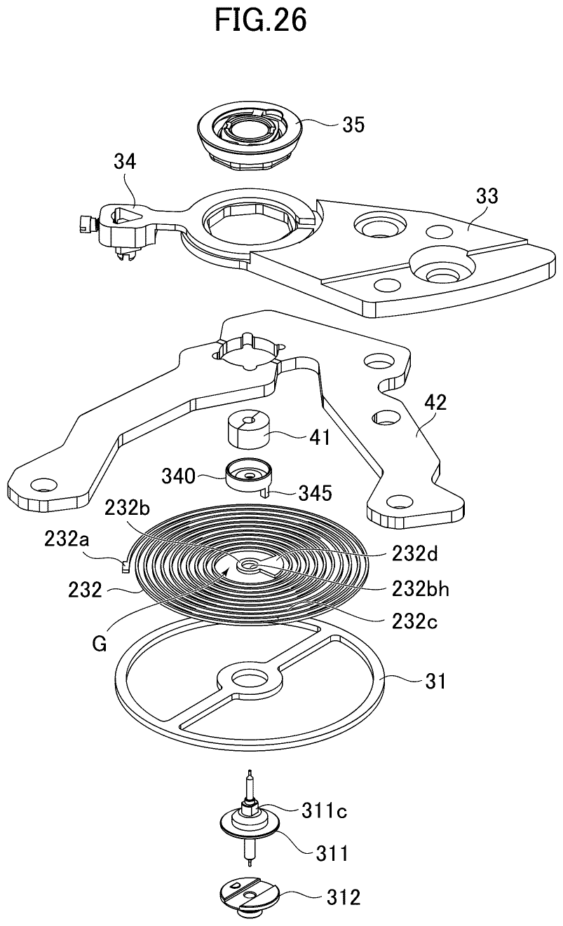

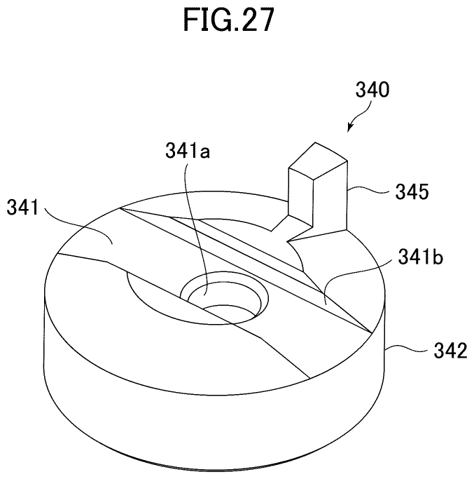

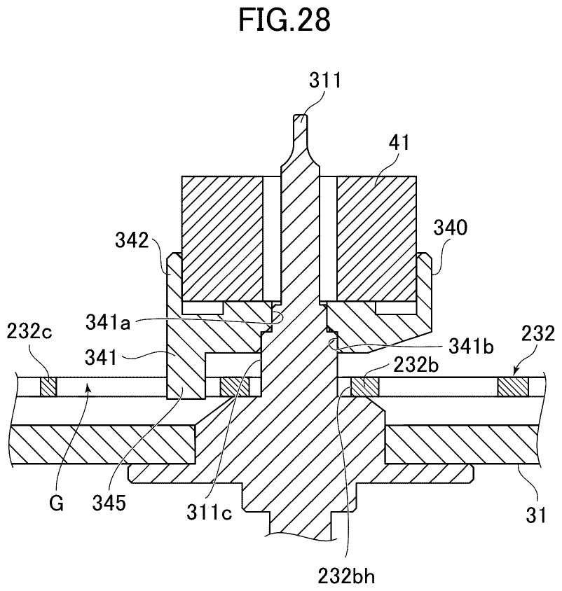

Next, with reference to FIG. 26 to FIG. 28, details of the configuration for achieving the spring torque shown in FIG. 25 are described. FIG. 26 is an exploded perspective view for illustrating the balance wheel, the balance staff, the permanent magnet, the hairspring, and their surrounding members in the second embodiment in a disassembled manner. FIG. 27 is a perspective view for illustrating a holding member in the second embodiment. FIG. 28 is a cross-sectional view for illustrating the balance wheel, the balance staff, the permanent magnet, the hairspring, and the holding member in the second embodiment.

In the second embodiment, the permanent magnet 41 is held by a holding member 340. The holding member 340 includes a bottom portion 341, and a cylindrical side wall portion 342 rising from the bottom portion 341. An inner diameter of the side wall portion 342 is substantially the same as an outer diameter of the permanent magnet 41, and the permanent magnet 41 is press-fitted into the side wall portion 342 so as to be rotated integrally with the holding member 340. In the bottom portion 341, an insertion hole 341a through which the balance staff 311 is to be inserted is formed. Further, in a lower surface of the bottom portion 341, a positioning groove 341b is formed as illustrated in FIG. 27 and FIG. 28. The fitting portion 311c of the balance staff 311 is fitted to the positioning groove 341b under a state in which the fitting portion 311c is inserted through the insertion hole 341a of the bottom portion 341. When the fitting portion 311c is fitted to the positioning groove 341b, the rotation center of the balance staff 311 is positioned with respect to the center position of the permanent magnet 41, and the holding member 340 is rotated integrally with the balance staff 311.

The hairspring 232 in the second embodiment includes, as illustrated in FIG. 26, an outer end portion 232a, an inner end portion 232b, a spiral spring portion 232c, and a connection portion 232d connecting the inner end portion 232b and the spring portion 232c to each other.

The outer end portion 232a of the hairspring 232 is fixed with respect to the stud support 34. Meanwhile, the inner end portion 232b of the hairspring 232 is not fixed with respect to the balance staff 311. In the inner end portion 232b, an opening 232bh through which the balance staff 311 is to be inserted is formed. As illustrated in FIG. 28, it is preferred that an inner diameter of the opening 232bh be slightly larger than an outer diameter of a part opposed to the opening 232bh of the balance staff 311 in a state of being inserted through the opening 232bh. With such a configuration, the balance staff 311 includes a period in which the balance staff 311 idly rotates with respect to the hairspring 232 in its forward/reverse rotational motion.

Moreover, the holding member 340 includes a projecting portion 345 which is a contact portion extending toward a direction opposite to the direction in which the side wall portion 342 protrudes. The projecting portion 345 is provided so as to be positioned in a gap G between the inner end portion 232b and the spring portion 232c in the hairspring 232. The projecting portion 345 is movable in the gap G between the inner end portion 232b and the spring portion 232c along with the rotation of the balance staff 311. It is preferred that the connection portion 232d be shaped to connect the inner end portion 232b and the spring portion 232c to each other so that the gap G allowing the movement of the projecting portion 345 is formed between the inner end portion 232b and the spring portion 232c.

When the holding member 340 is rotated integrally with the balance staff 311, the projecting portion 345 moves within the gap G. Then, when the angle of the balance staff 311 (balance wheel 31) becomes a predetermined angle, the projecting portion 345 collides with the connection portion 232d. In this manner, the rotational force from the holding member 340 is transmitted to the connection portion 232d, and the connection portion 232d is rotated together with the holding member 340. Further, the spring portion 232c is elastically deformed along with the rotation of the connection portion 232d. In this manner, the spring torque is caused.

As illustrated in FIG. 26, it is preferred that the planar shape of the connection portion 232d be a fan shape expanding toward a radially outer side. In addition, it is preferred that the period in which the balance staff 331 idly rotates with respect to the hairspring 232 be defined depending on the expansion degree of the fan shape of the connection portion 232d. When the fan shape of the connection portion 232d is greatly expanded, the period in which the balance staff 331 idly rotates with respect to the hairspring 232 is shortened, and the spring torque is increased. Meanwhile, when the expansion of the fan shape of the connection portion 232d is small, the period in which the balance staff 331 idly rotates with respect to the hairspring 232 is lengthened, and the spring torque is decreased.

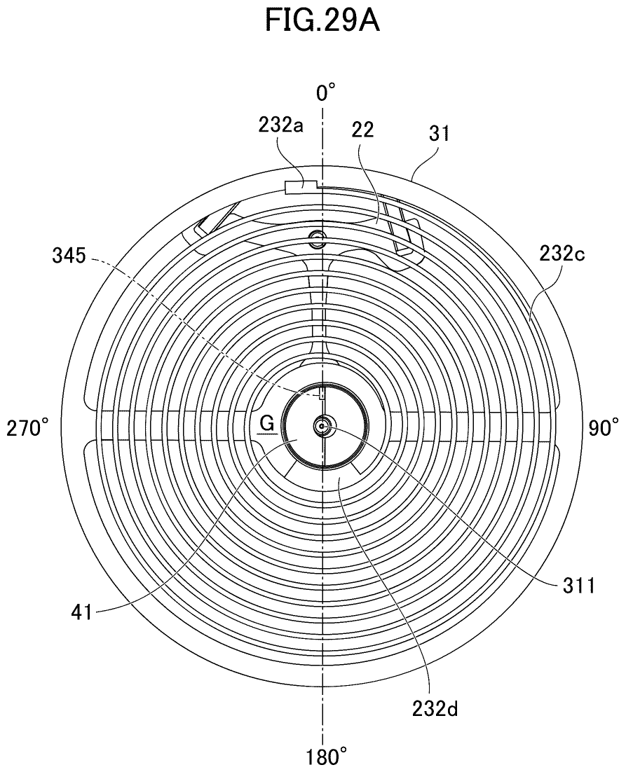

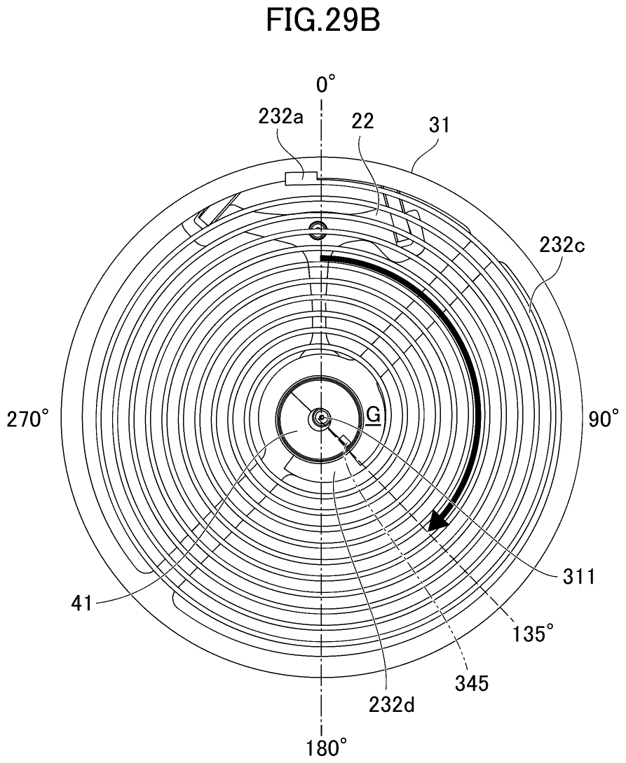

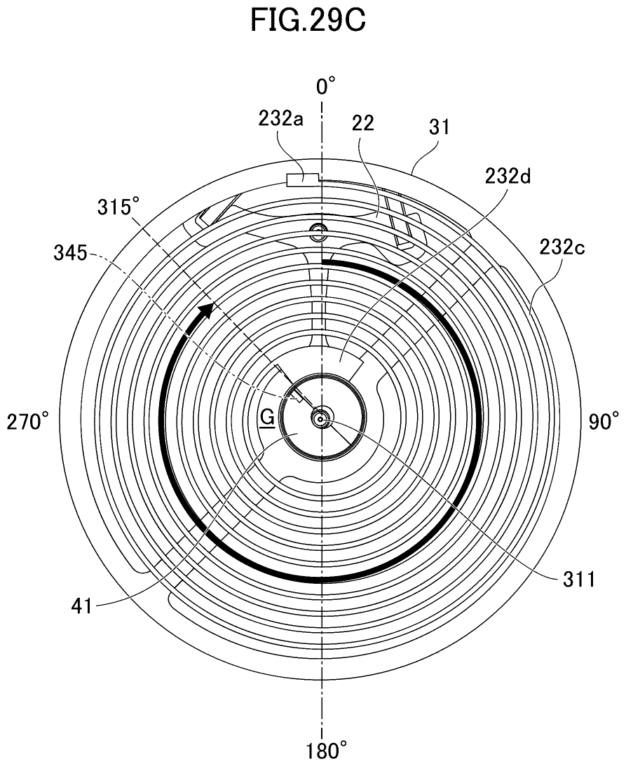

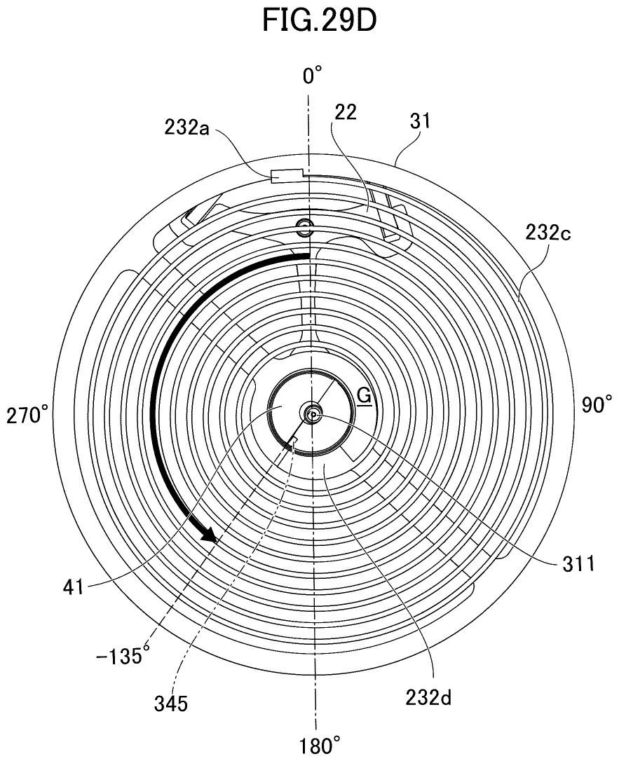

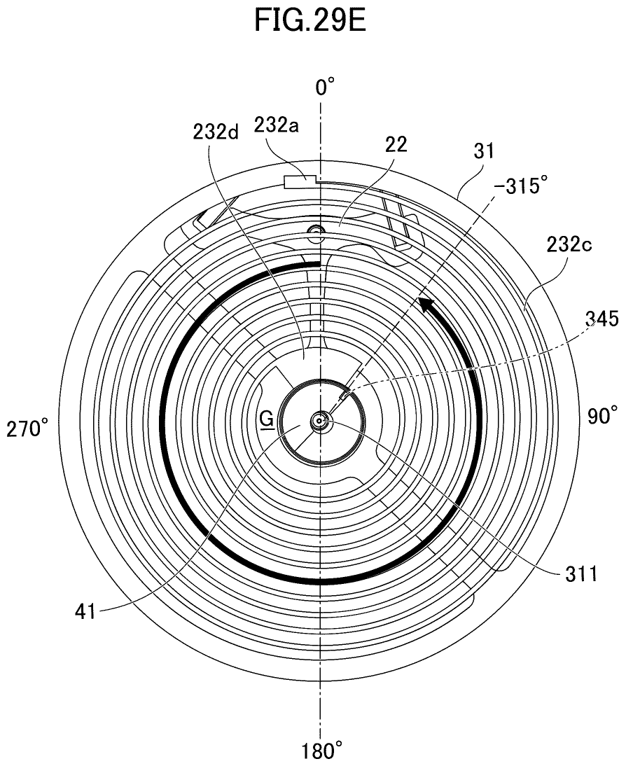

Moreover, with reference to FIG. 29A to FIG. 29E, specific examples of the operation of the hairspring at each rotation angle of the balance wheel in the second embodiment are described. FIG. 29A shows a state in which the rotation angle of the balance wheel is 0°. FIG. 29B shows a state in which the rotation angle of the balance wheel is 135°. FIG. 29C shows a state in which the rotation angle of the balance wheel is 315°. FIG. 29D shows a state in which the rotation angle of the balance wheel is −135°. FIG. 29E shows a state in which the rotation angle of the balance wheel is −315°. In FIG. 29A to FIG. 29E, the clockwise direction is the forward direction.

FIG. 29A to FIG. 29E show states as viewed from the permanent magnet 41 side (upper side of FIG. 28) with respect to the hairspring 232. FIG. 29A to FIG. 29E show the projecting portion 345 by an imaginary line. The spring portion 232c of the hairspring 232 is changed in shape when being expanded and contracted, but FIG. 29A to FIG. 29E do not express the change in the shape of the hairspring 232.

When the balance wheel 31 is rotated in the clockwise direction of the figure from the state of the rotation angle of 0°, the balance wheel 31 is brought from the state illustrated in FIG. 29A via the state illustrated in FIG. 29B to the state illustrated in FIG. 29C. Until the balance wheel 31 is brought from the state illustrated in FIG. 29A to the state illustrated in FIG. 29B, the projecting portion 345 is not in contact with the connection portion 232d, and thus the rotational force of the balance wheel 31 (balance staff 311) is not transmitted to the hairspring 232.

After that, when the rotation angle of the balance wheel 31 reaches 135°, the projecting portion 345 collides with the connection portion 232d. In this manner, the connection portion 232d of the hairspring 232 is rotated in the clockwise direction of the figure along with the rotation of the projecting portion 345. Along with the rotation of the connection portion 232d, the spring portion 232c is elastically deformed to generate the spring torque. Further, after the rotation angle of the balance wheel 31 reaches 345°, the balance wheel 31 is rotated in the counterclockwise direction of the figure along with the elastic deformation of the hairspring 232.

Further, when the rotation angle of the balance wheel 31 rotating in the counterclockwise direction of the figure reaches 135°, the rotation is continued while the projecting portion 345 is separated apart from the connection portion 232d. After that, the balance wheel 31 continues the rotation by the permanent magnet 41 receiving the action of the holding torque. The balance wheel 31 rotating in the counterclockwise direction of the figure passes through the rotation angle of 0°, and when the rotation angle reaches−135°, the projecting portion 345 collides with the connection portion 232d. In this manner, the connection portion 232d of the hairspring 232 is rotated in the counterclockwise direction of the figure along with the rotation of the projecting portion 345. Along with the rotation of the connection portion 232d, the spring portion 232c is elastically deformed to generate the spring torque. Further, after the rotation angle of the balance wheel 31 reaches−345°, the balance wheel 31 is rotated in the clockwise direction of the figure along with the elastic deformation of the hairspring 232. The balance wheel 31 repeats the above-mentioned forward/reverse rotational motion. During this motion, a period in which the spring torque of the hairspring 232 is generated and a period in which the spring torque of the hairspring 232 is not generated are repeated. As a result, the spring torque as shown in FIG. 25 can be obtained.

In the second embodiment, description has been given of an example in which the projecting portion 345 is brought into contact with the connection portion 232d under a state in which the rotation angle of the balance wheel 31 rotating in the clockwise direction of the figure is 135° or any of the subsequent angles, but the present invention is not limited thereto. It is only required that there be a period in which the projecting portion 345 is not in contact with the connection portion 232d while the rotation angle of the balance wheel 31 is at least 0° or more and less than 180°. The same holds true also for the counterclockwise direction.

In the second embodiment, for example, the interval between the permanent magnet 41 and the soft magnetic core 42, the interval between the notches n11, n12, n21, and n22, and the shapes of the notches n11, n12, n21, and n22 are adjusted so that, as shown in FIG. 25, at 135° and the subsequent angles, the holding torque is also increased in a similar tendency in accordance with the slope of the increase of the spring torque of the hairspring 232. In this manner, the spring torque and the holding torque greatly cancel the torque, and further lower oscillation as compared to the first embodiment can be achieved. Further, in the second embodiment, the deformation amount of the hairspring 232 can be decreased as compared to the case of the first embodiment, and hence the pitch of the hairspring 232 can be designed to be small. In this manner, the hairspring 232 and the balance wheel 31 can be downsized, and the degree of freedom in the selection of the shape and the material of the hairspring 232 is increased. Moreover, as shown in FIG. 25, the slope of the spring torque can be increased as compared to that of FIG. 8 in the first embodiment, and the width of the spring portion 232c of the hairspring 232 is increased or the spring length is decreased so that the rigidity can be improved. With the rigidity of the hairspring 232 being improved, the handling at the time of assembling the hairspring 232 is facilitated.

### Modification Example of Second Embodiment

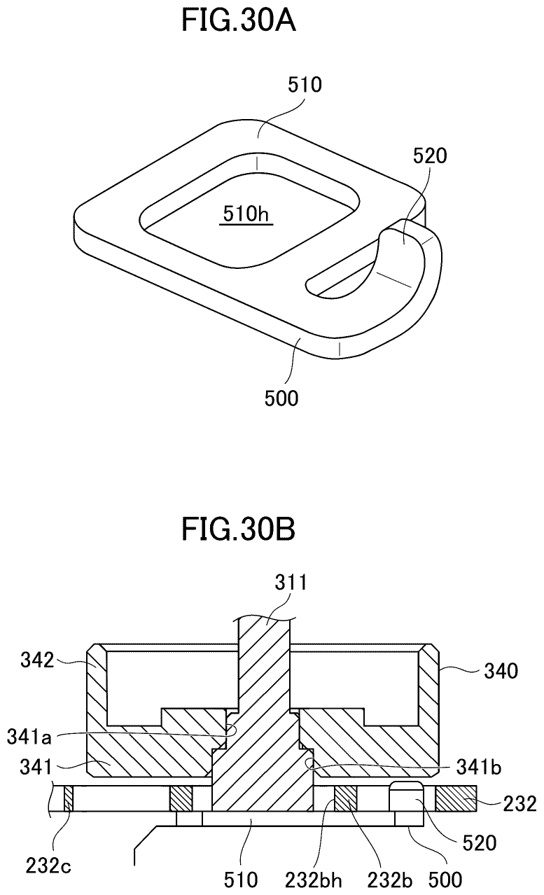

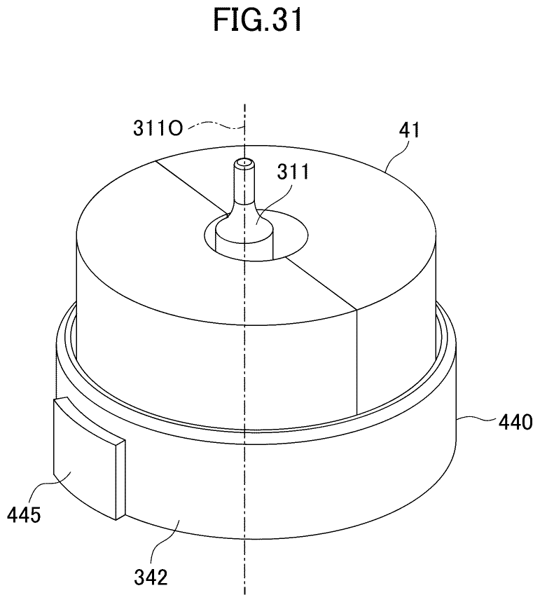

FIG. 30A is a perspective view for illustrating a projecting portion in a modification example of the second embodiment. FIG. 30B is a cross-sectional view in a case of using the projecting portion in the modification example of the second embodiment.

FIG. 27 and the like show an example in which the holding member 340 includes the projecting portion 345 which is the contact portion, but the present invention is not limited thereto. That is, the projecting portion 345 may be provided in a member separate from the holding member 340.

FIG. 30A and FIG. 30B show an example using a contact member 500. The contact member 500 includes a frame portion 510 in which an insertion hole 510h through which the balance staff 311 is to be inserted is formed, and a projecting portion 520 positioned on the outer side of the frame portion 510.

The projecting portion 520 has a function similar to that of the projecting portion 345 illustrated in FIG. 27 and the like. The contact member 500 is rotated integrally with the balance staff 311. When the contact member 500 is rotated, the projecting portion 520 collides with the connection portion 232d of the hairspring 232, and the rotational force of the balance staff 311 is transmitted to the hairspring 232.

FIG. 30B shows an example in which the hairspring 232 is provided between the contact member 500 and the holding member 340, but the present invention is not limited thereto. For example, the contact member 500 may be provided between the hairspring 232 and the holding member 340. In this case, it is preferred that the projecting portion 520 protrude in a direction opposite to the direction illustrated in FIG. 30B.

Although detailed description is omitted, the configurations of the second embodiment and its modification example may be combined with the configurations of the first modification example to the third modification example of the first embodiment described with reference to FIG. 22 to FIG. 24.

### [Others]

FIG. 31 is a perspective view for illustrating a modification example of the holding member. In FIG. 11 and the like, description has been given of an example in which the permanent magnet 41 adopts the eccentric structure. That is, description has been given of an example in which the center position 410 of the permanent magnet 41 accommodated in the holding member 140 is arranged so as to be shifted from the rotation center 3110 of the balance staff 311 inserted through the insertion hole 141a. In such a configuration, a center of gravity of a rotary member formed of the permanent magnet 41 and the holding member 140 is deviated from its rotation center. As a result, there is a possibility that the posture of the permanent magnet 41 is affected.

A holding member 440 illustrated in FIG. 31 includes a center-of-gravity adjusting portion 445 provided on the side wall portion 342. The center-of-gravity adjusting portion 445 is a part provided for adjusting the center of gravity of the rotary member formed of the permanent magnet 41 and the holding member 440. As illustrated in FIG. 31, it is preferred that the center-of-gravity adjusting portion 445 be provided on a side closer to the rotation center 3110 of the balance staff 311 in the circumferential direction.

The center-of-gravity adjusting portion 445 illustrated in FIG. 31 is merely an example, and the present invention is not limited thereto. For example, the center-of-gravity adjusting portion 445 is not required to be a part of the holding member 440, and may be a member separate from the holding member 440. Further, the holding member 440 may have a cutout or a groove formed therein as the center-of-gravity adjusting portion. In this case, it is preferred that the cutout or the groove be formed on a side farther from the rotation center 3110 of the balance staff 311 in the circumferential direction.

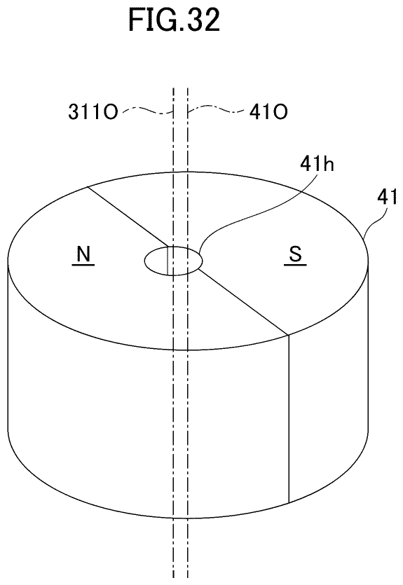

FIG. 32 is a perspective view for illustrating a modification example of the permanent magnet. In FIG. 11, FIG. 28, and the like, description has been given of an example in which the permanent magnet 41 is rotated together with the balance staff 311 via the holding member 140 or 340, but the present invention is not limited thereto. The permanent magnet 41 may be directly mounted to the balance staff 311. In this case, it is preferred that, as illustrated in FIG. 32, the center of the insertion hole 41h (that is, the rotation center 3110 of the balance staff) be shifted from the center position 410 of the circular permanent magnet 41. Further, it is preferred that the balance staff be press-fitted to the insertion hole 41h so that the permanent magnet 41 is rotatable integrally with the balance staff. When the permanent magnet 41 illustrated in FIG. 32 is used without using the holding member, it is preferred to use the contact member 500 illustrated in FIG. 30A. The insertion hole 41h may be shifted to any one of the N-pole side and the S-pole side.

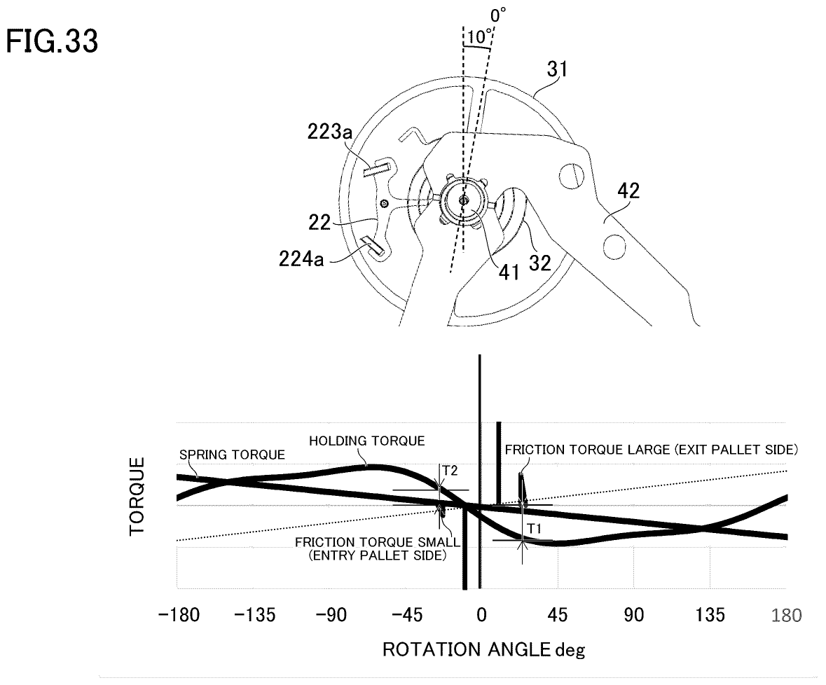

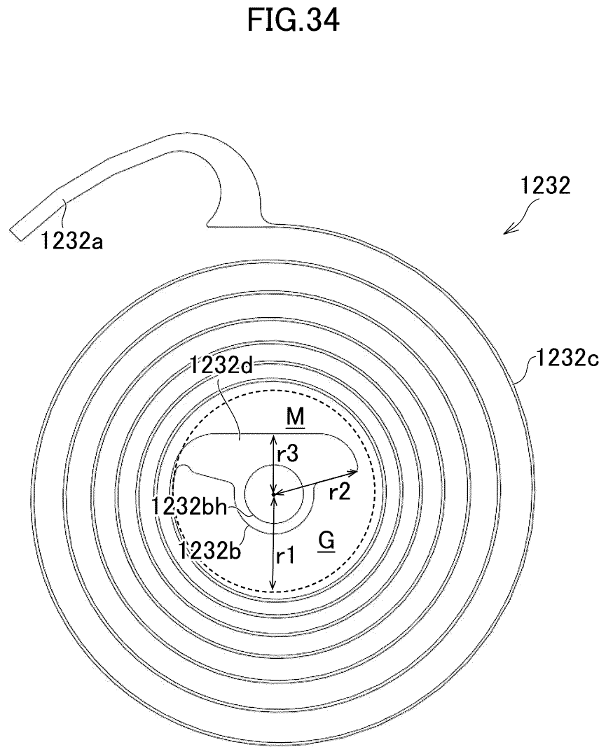

FIG. 33 is an explanatory view for illustrating a modification example regarding arrangement angles of the permanent magnet and the soft magnetic core. In the escapement 20, in some cases, due to a mechanical error, a static frictional force caused at a contact surface between the entry pallet 223a and the tooth of the escape wheel and pinion 21 and a static frictional force caused at a contact surface between the exit pallet 224a and the tooth of the escape wheel and pinion 21 may have different magnitudes. For example, in a case in which the static frictional force is larger on the exit pallet 224a side, when the balance wheel 31 returns to 0° from a positive rotation angle, there is a fear in that the holding torque with respect to the static frictional force caused at the contact surface between the exit pallet 224a and the escape wheel and pinion 21 is insufficient and thus the escape wheel and pinion 21 is not released.

When the static frictional force is unbalanced between the entry pallet 223a side and the exit pallet 224a side as described above, it is preferred that an eccentric direction of the permanent magnet 41 and the soft magnetic core 42 be tilted. FIG. 33 shows an example in which the eccentric direction of the permanent magnet 41 and the soft magnetic core 42 is arranged so as to be tilted by 10° from the arrangement of the first embodiment. Further, the balance wheel 31 and the hairspring 32 are also arranged so as to be tilted by 10° from the arrangement of the first embodiment. In this case, the eccentric direction refers to a direction in which the center position of the permanent magnet 41 and the center position of the opening of the soft magnetic core 42 are shifted from the rotation center of the balance staff 311. In other words, the eccentric direction is a direction in which a line connecting the rotation center of the balance staff 311 and the center position of the permanent magnet 41 to each other extends.

When such an arrangement is adopted, as shown in the graph at the lower stage of FIG. 33, as compared to the graph of FIG. 8 in the first embodiment, the holding torque is caused with a delay of 10° in the positive rotation direction. The relative position between the permanent magnet 41 and the soft magnetic core 42 is the same as that of the first embodiment, and hence the waveform of the holding torque itself is substantially similar to that of FIG. 8.

The graph at the lower stage of FIG. 33 shows an example in which a holding torque T1 is caused at a timing at which the static frictional force on the exit pallet 224a side is caused, and a holding torque T2 is caused at a timing at which the static frictional force on the entry pallet 223a side is caused. When the arrangement illustrated at the upper stage of FIG. 8 is adopted, the timing at which the holding torque is caused is shifted, and thus T1>T2 is satisfied. Accordingly, the escape wheel and pinion 21 is liable to be released on the exit pallet 224a side on which the static frictional force is large.

As described above, even when the static frictional force is unbalanced between the entry pallet 223a side and the exit pallet 224a side, the escapement 20 can be normally operated by adopting the arrangement illustrated in FIG. 33. FIG. 33 shows an example in which the eccentric direction is arranged so as to be shifted by 10° so that the holding torque becomes larger at the timing at which the static frictional force on the exit pallet 224a side is caused, but the present invention is not limited thereto. It is preferred that the eccentric direction be set as appropriate depending on which of the entry pallet 223a side and the exit pallet 224a side has a larger static frictional force or how much difference in the static frictional force is present. The arrangement illustrated in FIG. 33 can be applied to, other than the first embodiment, the second embodiment and the modification examples thereof.

FIG. 34 is a plan view for illustrating a modification example of the hairspring. A hairspring 1232 illustrated in FIG. 34 is a modification example of the hairspring 232 illustrated in FIG. 26 and the like. The hairspring 1232 includes an outer end portion 1232a, an inner end portion 1232b, a spiral spring portion 1232c, and a connection portion 1232d connecting the inner end portion 1232b and the spring portion 1232c to each other. A planar shape of the connection portion 1232d is a shape including a part expanding toward the radially outer side. The connection portion 1232d defines the period in which the balance staff 311 idly rotates with respect to the hairspring 1232 depending on the expansion degree of the shape of the part expanding toward the radially outer side.

In the above-mentioned second embodiment, description has been given of an example in which the planar shape of the connection portion 232d is a fan shape. However, when the planar shape of the connection portion 232d is a fan shape, at the time of contraction of the spring portion 232c, in some cases, the contraction range of the spring portion 232c may be restricted by the connection portion 232d. In view of the above, the hairspring 1232 illustrated in FIG. 34 adopts a configuration in which an allowable amount of the contraction of the spring portion 1232c is increased as compared to the fan-shaped hairspring 232. Specifically, the planar shape of the connection portion 1232d is formed into a shape including a part in which a distance from the rotation center of the hairspring 1232 to an end portion in the radial direction is shorter than a radius of a rotation locus of an outermost portion of the connection portion 1232d in the radial direction. It is preferred that the outermost portion of the connection portion 1232d be a part having a farthest distance from the rotation center of the hairspring 1232 and being connected to the inner end of the spring portion 1232c.

A dotted-line circle of FIG. 34 indicates the rotation locus of the outermost portion of the connection portion 1232d. The radius of the rotation locus is represented by r1. The connection portion 1232d includes a part having a distance from the rotation center shorter than the radius r1. That is, the connection portion 1232d includes a part that rotates within the rotation locus of the outermost portion. Specifically, the connection portion 1232d includes a part in which a distance from the rotation center of the hairspring 1232 is r2 (<r1). Further, it is preferred that the connection portion 1232d include a part in which the distance from the rotation center of the hairspring 1232 is r3 (<r2). When the connection portion 1232d having such a planar shape is adopted, a contraction allowing region M for allowing contraction of the spring portion 1232c is formed. The contraction range of the spring portion 1232c is increased by the amount corresponding to the formed contraction allowing region M.

The rate adjustment means 40 obtains the detection signal based on the operation of the permanent magnet 41 magnetized into two poles. When a member causing a magnetic effect is present around the permanent magnet 41, there is a possibility that the detection accuracy is reduced. Accordingly, it is preferred that, as a material of a member present around the permanent magnet 41, a material causing less magnetic effect be adopted. For example, it is preferred that a resin material be used as materials of the support member 33 and the stud support 34. Further, it is preferred that phosphor bronze, brass, or the like be used as a material of the fixing tool for fixing the support member 33 with respect to the main plate 10. Further, it is preferred that a resin material, aluminum, brass, or the like be used as the material of the balance wheel 31.

Further, although not shown, it is preferred that the mechanical timepiece 1 include, on a dial or a back cover, an opening or a transparent portion for allowing the balance wheel 31 to be visually recognized from the outside.

The invention claimed is:

1. A mechanical timepiece, comprising:
a power source;
a speed governing mechanism including:
a balance wheel to be driven by motive power supplied from the power source; and
a hairspring to be elastically deformed so as to cause the balance wheel to perform a forward/reverse rotational motion;
a permanent magnet which includes a first polarity portion and a second polarity portion having a polarity different from a polarity of the first polarity portion, and which is configured to perform a forward/reverse rotational motion along with the forward/reverse rotational motion of the balance wheel;
a coil;
a soft magnetic core including:
a first end portion provided so as to cause a magnetic resistance with respect to the permanent magnet; and
a second end portion provided on a side opposite to the first end portion through intermediation of the permanent magnet so as to cause a magnetic resistance with respect to the permanent magnet; and
a control circuit for performing rate adjustment based on a detection voltage and a normal frequency of a reference signal source, the detection voltage being caused in the coil by a motion of the permanent magnet accompanying a forward direction motion and a reverse direction motion of the balance wheel,
wherein the permanent magnet is arranged so that:
at a first angle position under a state in which the hairspring is brought to a neutral position of elastic deformation thereof, the first polarity portion is opposed to the first end portion with a first interval, and the second polarity portion is opposed to the second end portion with a second interval;
at a second angle position rotated by 180° from the first angle position, the first polarity portion is opposed to the second end portion with a third interval, and the second polarity portion is opposed to the first end portion with a fourth interval; and
the second interval is smaller than the first interval, and a difference between the fourth interval and the third interval is smaller than a difference between the first interval and the second interval.

2. The mechanical timepiece according to claim 1,
wherein the permanent magnet has a circular planar shape, and
wherein a center position of the permanent magnet is arranged at a position different from a rotation center of a balance staff which is a rotary shaft of the balance wheel.

3. The mechanical timepiece according to claim 2,
wherein, in the soft magnetic core, an inner peripheral surface of the first end portion and an inner peripheral surface of the second end portion form an opening having a circular planar shape, and
wherein a center position of the opening of the soft magnetic core is arranged at a position different from the rotation center.

4. The mechanical timepiece according to claim 3, wherein, under a state in which the permanent magnet is brought to the first angle position, the center position of the permanent magnet and the center position of the opening of the soft magnetic core are at positions symmetrical with each other with respect to the rotation center.

5. The mechanical timepiece according to claim 4, wherein, under a state in which the permanent magnet is brought to the second angle position, the center position of the permanent magnet and the center position of the opening of the soft magnetic core match each other.

6. The mechanical timepiece according to claim 3, wherein, under a state in which the permanent magnet is brought to the first angle position, the center position of the permanent magnet, the rotation center of the rotary shaft, and the center position of the opening of the soft magnetic core are arranged side by side on a straight line orthogonal to a boundary line between the first polarity portion and the second polarity portion.

7. The mechanical timepiece according to claim 3, further comprising:
a support member which is configured to support the soft magnetic core, and is fixed to a main plate; and
a positioning frame which is mounted to the support member, and is configured to position the soft magnetic core,
wherein the positioning frame is provided so that a center position thereof matches a rotation center of a balance staff which is a rotary shaft of the balance wheel, and includes a positioning projection which has an annular shape and is configured to be fitted to the opening of the soft magnetic core, and
wherein a center position of the positioning projection is arranged at a position different from the center position of the positioning frame.

8. The mechanical timepiece according to claim 1, further comprising a holding member configured to hold the permanent magnet,
wherein the holding member has formed therein an insertion hole through which a balance staff is to be inserted, and the holding member is to be rotated integrally with the balance staff under a state in which the balance staff is inserted through the insertion hole,
wherein a center position of the insertion hole is arranged at a position different from a center position of the holding member, and
where the balance shaft is a rotary shaft of the balance wheel.

9. The mechanical timepiece according to claim 1, wherein, under a state in which the coil is brought to a de-energized state and the permanent magnet is brought between the first angle position and the second angle position, a magnetic attraction force acts between the permanent magnet and the soft magnetic core in a direction in which the permanent magnet is rotated toward the first angle position.

10. The mechanical timepiece according to claim 1, further comprising:
a cap jewel configured to abut against one end of a balance staff which is a rotary shaft of the balance wheel to perform positioning of the balance staff in an axial direction; and
a cap jewel holding member which is formed into an annular shape surrounding at least a part of an outer peripheral surface of the permanent magnet, and is configured to hold the cap jewel,
wherein the cap jewel holding member is made of a magnetic material, and has a cutout formed in at least a part of a portion of the cap jewel holding member to be opposed to the outer peripheral surface of the permanent magnet.

11. The mechanical timepiece according to claim 1, wherein a forward/reverse rotational motion of a balance staff, which is a rotary shaft of the balance wheel, includes at least a period in which the balance staff idly rotates with respect to the hairspring and a period in which the balance staff transmits a rotational force to the hairspring and elastically deforms the hairspring.

12. The mechanical timepiece according to claim 11, wherein the hairspring is unfixed to the balance staff.

13. The mechanical timepiece according to claim 11, further comprising a contact portion configured to repeat contact and non-contact with respect to the hairspring along with the forward/reverse rotational motion of the balance staff.

14. The mechanical timepiece according to claim 13, wherein the hairspring includes: a spring portion which is elastically deformable and has a spiral shape; an inner end portion through which the balance staff is to be inserted; and a connection portion which connects the spring portion and the inner end portion to each other and forms a gap that allows the contact portion to move between the spring portion and the inner end portion.

15. The mechanical timepiece according to claim 14, wherein a period in which a rotation angle of the balance staff is at least 0° or more and less than 180° includes a period in which the contact portion is not in contact with respect to the connection portion.

16. The mechanical timepiece according to claim 14, further comprising a holding member which is configured to hold the permanent magnet, and is to be rotated integrally with the balance staff,
wherein the contact portion is provided in the holding member.

17. The mechanical timepiece according to claim 14, further comprising a holding member which is configured to hold the permanent magnet, and is to be rotated integrally with the balance staff,
wherein the contact portion is provided in a member separate from the holding member, the member being configured to be rotated integrally with the balance staff.

18. The mechanical timepiece according to claim 14,
wherein a planar shape of the connection portion is a shape including a part expanding toward a radially outer side, and
wherein a period in which the balance staff idly rotates with respect to the hairspring is defined depending on an expansion degree of the part expanding toward the radially outer side.

19. The mechanical timepiece according to claim 14, wherein a planar shape of the connection portion is a shape including a part in which a distance from a rotation center of the hairspring to an end portion in a radial direction is shorter than a radius of a rotation locus of an outermost portion of the connection portion in the radial direction.

20. The mechanical timepiece according to claim 8, wherein the holding member includes a center-of-gravity adjusting portion configured to adjust a center of gravity of a rotary member formed of the permanent magnet and the holding member.
